(19) United States
(12) Patent Application Publication
(10) Pub. No.: US 2009/0183083 A1
(43) Pub. Date: Jul. 16, 2009

(54) METHOD AND SYSTEM FOR DISPLAYING INFORMATION ON A MAP

(76) Inventor: JASON D. HEDGES, EDGEWOOD, MD (US)

Correspondence Address: DLA PIPER LLP US, P. O. BOX 2758, RESTON, VA, 20195, US

(21) Appl. No.: 12/238,238

(22) Filed: Sep. 25, 2008

Related U.S. Application Data
(60) Provisional application No. 60/960,470, filed on Oct. 1, 2007.

(51) Int. Cl. G06F 17/30; G06F 15/16; G06F 3/048; G06F 12/08

(52) U.S. Cl. 715/738; 709/203; 707/E17.018; 707/3; 711/126; 707/E17.016; 711/E12.016

(57) ABSTRACT

A method and system for providing a map of geographical data, comprising: connecting a client to a server utilizing a Web browser; accepting a request from the client of a geographical viewing area of a desired basemap; searching a server directory for a list of tiles corresponding to the geographical viewing area of the desired basemap; returning to the client the list of tiles enabling the client to determine if any of the tiles are in a local cache; generating any tiles in the local cache from the local cache; and generating any tiles not in the local cache from the server; wherein the tiles generate a map of at least two dimensions; and wherein all communication between the server and the client is done utilizing STML.

This application claims priority to provisional application 60/960,470, filed on Oct. 1, 2007, and entitle “Method and System for Displaying information on a Map”, which is herein incorporated in its entirety by reference.

### DESCRIPTION OF THE FIGURES

FIGS. 1 and 11 illustrates an overview of a method for mapping geographical data from a database, according to several embodiments.

FIGS. 2-8E and 17-20 illustrate examples of various widgets, according to several embodiments.

FIGS. 9A-10D and 21-29 illustrate examples of various tools, according to several embodiments.

### DESCRIPTION OF EMBODIMENTS OF THE INVENTION

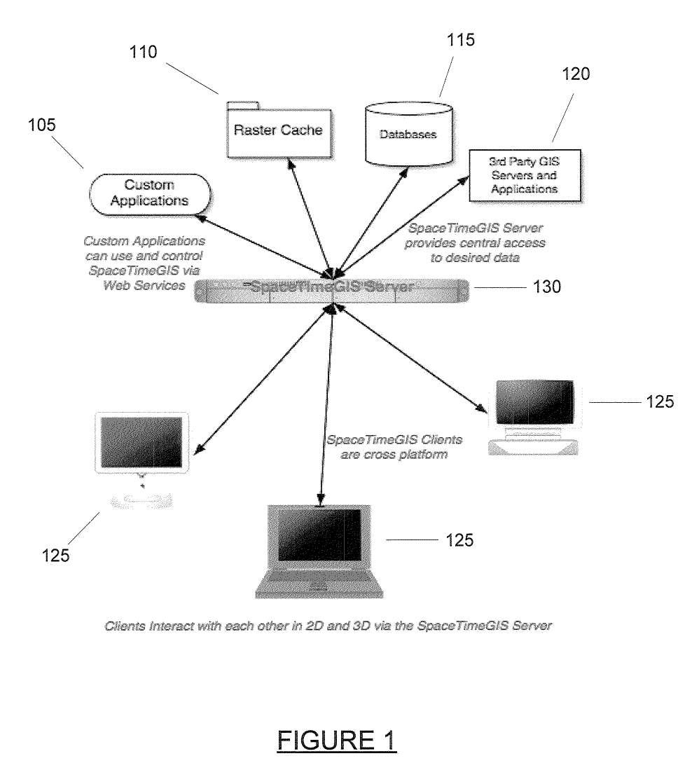

FIG. 1 illustrates an overview of a method for mapping geographical data from a database, according to one embodiment of the invention. Clients 125 can initiate a connection to the server 130. If the client is valid, the server can generate a session and send the key to the client. The user's client session can be identified by the key generated by the server. Thus, the server can send it data, commands, or requests that can originate from the client itself, 3^{rd} party applications, or another client. The server can process the requests, perform the necessary operations and return the results. The server can interact with other applications and resources 105 and/or 120 and can act as a mediator for the clients.

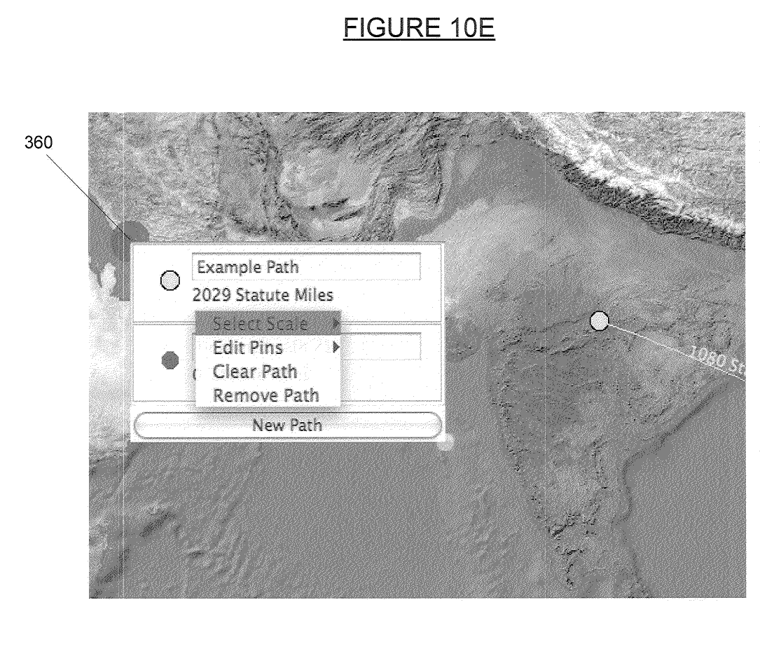

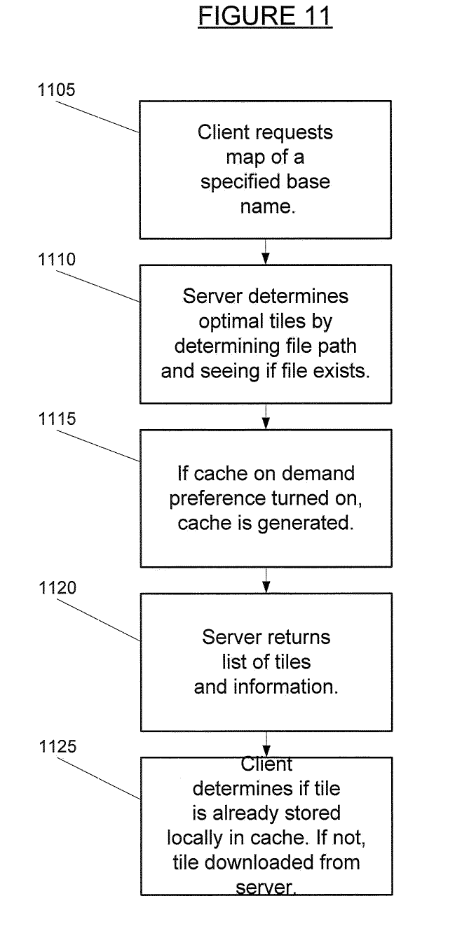

Maps that are created (in 2D, 3D, etc.), can be cached to provide quick access to the maps. FIG. 11 illustrates an example of how caching can be performed. In one embodiment, all the desired layers and areas can be cached at once using tile cache builder tool. For example, an administrator can open up the server manager tool and select the option to build cache. The administrator can then select the northern, southern, eastern, and western bounds and all of the levels (0-26) that the administrator would like to cache. The tool can then build and catalog all the cache on the server. In an additional embodiment, cache-on-demand can be done. In this embodiment, only part of the cache is built. Once a client tries to visit a level and area on the map that is not cached but is marked within a cache-on-demand area, the server can generate the cache tiles and provide the user with a link back to them when tiles are complete. For example, if a user were to navigate to the city of Paris at level 10 where there was already cache but then zoom in one more level to level 11 where there was no cache, it would trigger cache to be built. The server could calculate the tiles (i.e., adjacent blocks of pixels on a screen) needed for the viewing area and send off requests to build that cache in separate threads (i.e., a sub-process that is part of a larger process or program). As each thread completed, the client would be notified and the tile corresponding to the thread would be built. The original user may notice a longer delay than normal (e.g., compared to the cached tiles) in viewing the tile. However, the next user who visits that area would likely not notice a delay because that area was cached by the first user's request.

Referring again to FIG. 11, in 1105, the client(s) 125 requests to view a certain area of a specified base map. The base map can be any map such as a world map, a states map, a National Geographic map, or a user created map. In 1110, the server 130 determines the optimal tiles that the map should be split into. To do this, the server determines the file path and checks to see if the file exists. If the file does not exist, the optimal tile does not exist. The server then looks for the next best tile that does exist. In 1120 (assuming the user has the preference of cache on demand turned on), the server 130 returns a list of tiles and their information to the client 125. Tile information can comprise the cache level, row number, column number, URL to the tile on the server, the geographical bounds in decimal degrees, and the date it was generated. The following is an example of xml data (the tile information) that can be returned to the client.

<cacherequested>
<servicename>required</servicename>
<tile>
<cachelevel>required</cachelevel>
<row>required</row>
<column>required</column>
<href>required</href>
<extent>required</extent>
<date>5/9/79</date>
</tile>
</cacherequeted>

It should be noted that the xml data above is a proprietary format, referred to for identification purposes as STML (Space Time Markup Language), that can be utilized in one embodiment. STML is a proprietary specification that describes commands and datasets. STML can allow geographic datasets to be transmitted with little overhead. It can provide a method to control clients (for example, it can send a client to a certain area on a map). STML can allow clients to be queried for information (for example, it can retrieve selected geographical areas). STML can also allow the client(s) and the server(s) to communicate what map cache is available and where it can be retrieved. With STML, the commands can be issued as xml tags to the client or server. For example, if a 3^{rd} party application wishes to send a certain client to an area on the map, they may do so by calling a web service that will send STML to the client. The client is identified by with a unique key for its session. The server then sends STML to the client telling it to go to that specific area requested Inside the tags can be any parameters that the receiver may need to complete the request. For example, above is the syntax for STML sent from the server to the client for returned map cache. The tag “cacherequested” identifies the operation. Inside that tag are the parameters needed to complete the operation. The tag “href” identifies the location of the tile to be downloaded and the other tags give the client information about where to place the tile and how old the tile is. Likewise, datasets can be expressed first by a tag with the name of their type and then any properties or data within that type tag. For example, a polygon can be easily represented inside STML. The tag “gisobject” appears at the root with the property of “type” as polygon. This shows that the data structure represents a polygon. Inside the “gisobject” tags attributes of the data structure are represented as tags. There exist tags to represent how the polygon should be drawn, a unique identifier, attribute data about the polygon, and any temporal data. Redundant data such as vertices can have only one tag to identify the set to decrease the amount of overhead. In the STML structure for a polygon, vertices are only identified by outer rings or inner rings. Inside those tags, vertices are comma delimited to keep down the number of STML tags needed to identify each point in the polygon. STML allows specific data types to be quickly serialized and sent to the client or server. This can be because the STML number of tags and length is designed for each data type to be as small as possible to minimize the amount of XML overhead. STML was specifically designed for this application so tag requests can be made to get data quickly. An example of this is the method for retrieving available basemaps. The tag “basemaps” is the only tag needed to get a response from the server. STML is based on the XML standard. STML can use a tag-based structure that contains attributes and child elements. STML can be used by the applications and/or could be fed into the server or client to perform desired functions. The server and clients can constantly be listening for STML. Once a message is received that is perceived to be STML, it can be verified and then sent off to be processed by another thread. If valid STML is sent to the server with a valid key identifying a client session, that server can generate the appropriate response and send it to the client whose key matches that which was sent.

Referring again to FIG. 11, in 1125, the client 125 uses the file information to determine if the tile is already stored locally in the cache. If not, any tiles that are not stored in the cache are downloaded from the server each in a separate thread 130. Each tile can be downloaded and loaded in a separate thread so that a map appears to load them simultaneously. Otherwise, each tile could appear one after another and the map could thus appear much slower. The map can be cached by recursively finding the middle of the map and splitting it into several tiles (e.g., four tiles). Each iteration of the splitting of the map is a cache level. Each tile can be indexed by its row and column starting at the upper left hand corner. By caching the tiles in this fashion, the extent of each tile can be determined by knowing its cache level, row number (index), and column number (index). This allows tiles to be stored in a file system using a standard naming scheme. When a tile is requested, the name is calculated and the user can read the image directly from the cache. This averts the overhead of querying a database.

Note that the number of tiles can grow exponentially with each level. At level zero only one tile is generated. At level one, 4 tiles are generated. At level 2, 16 tiles are generated. The number of possible tiles can be calculated at any level by 4̂A(cache level). The number of rows or columns at a cache level can be calculated by 2̂A(cache level). To find the appropriate cache level based on a given extent, the difference in degrees from the largest part of the extent (north-south or east-west) is used as the desired tile size. The cache level can be determined by taking the log base 2 of (360/desired tile size) for a x based tile size and the log base 2 of (180/desired tile size) for a y based tile size. Therefore, all the tiles have a width 2 times wider than their height.

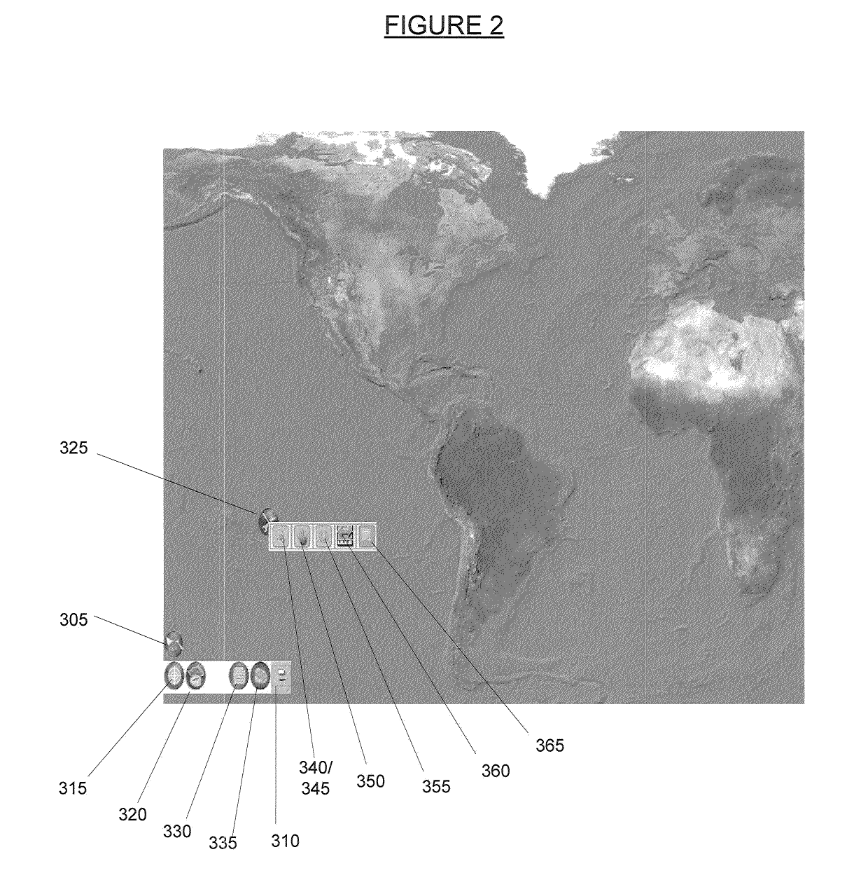

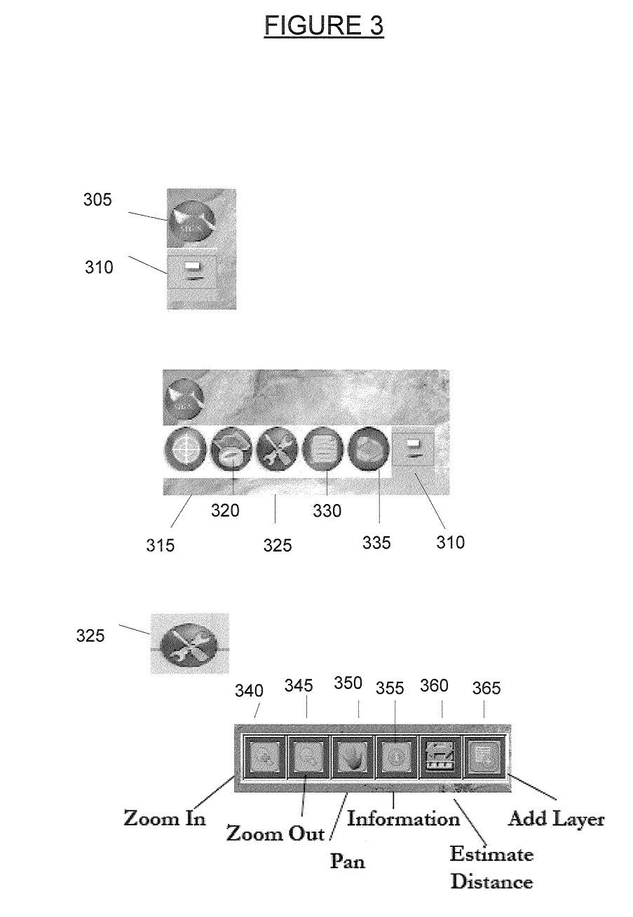

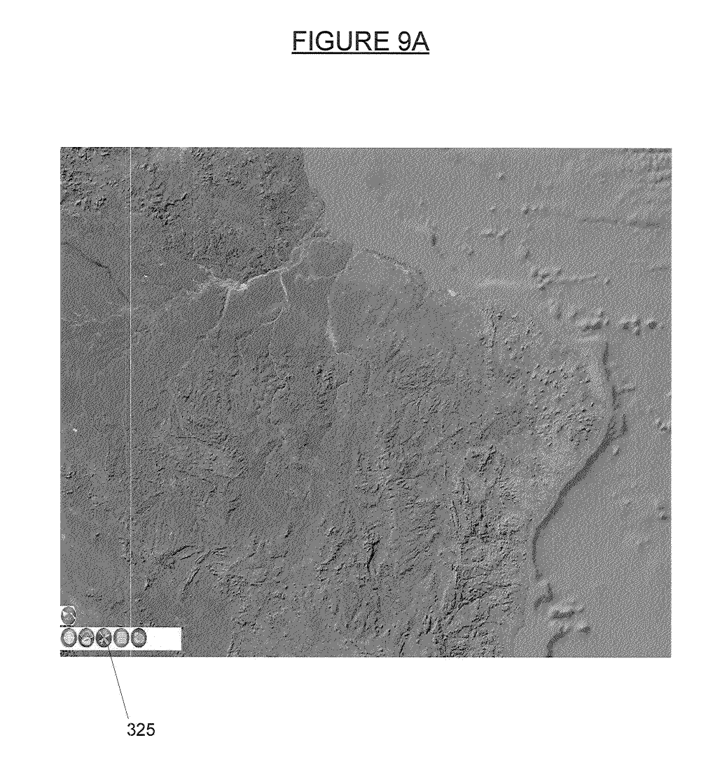

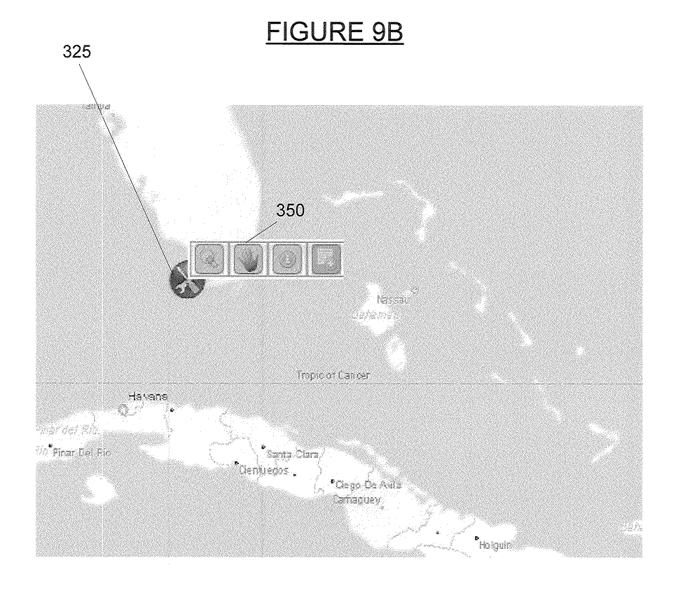

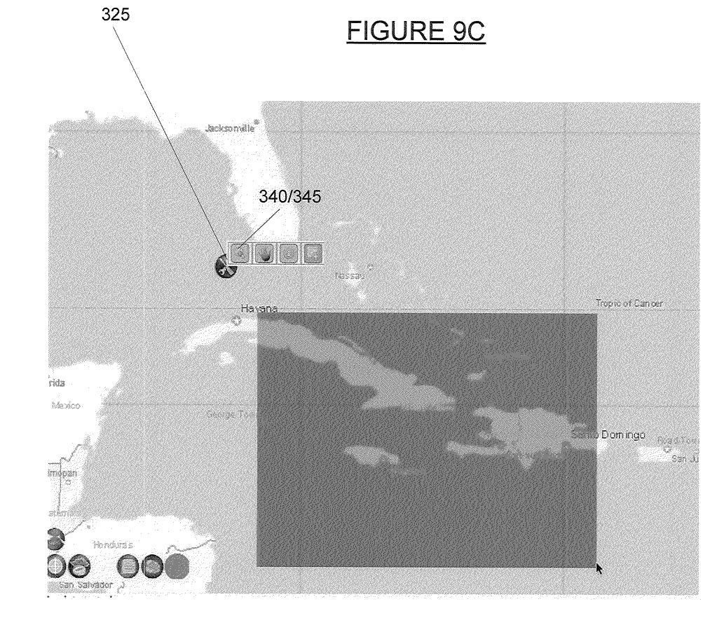

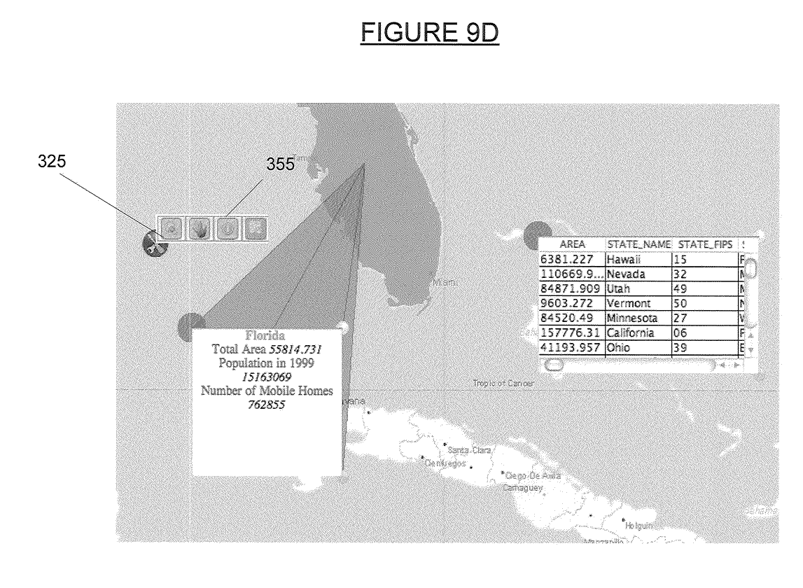

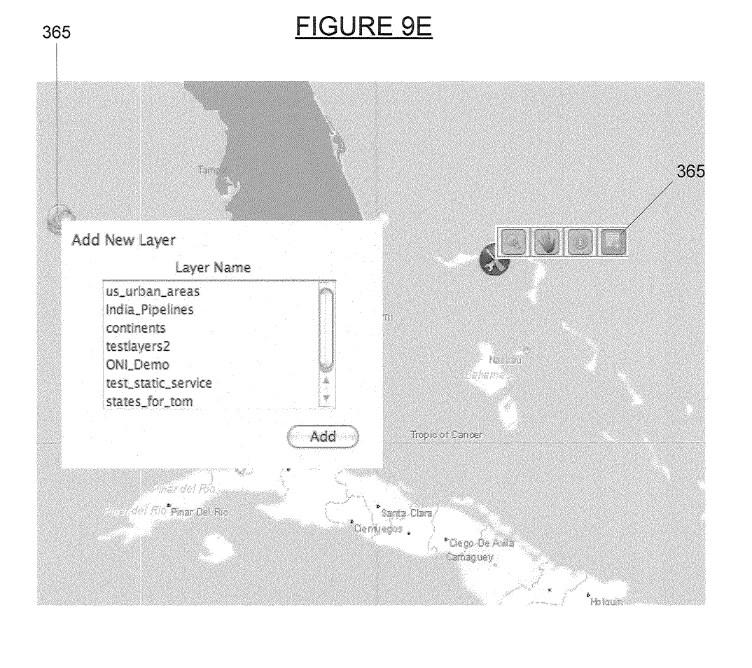

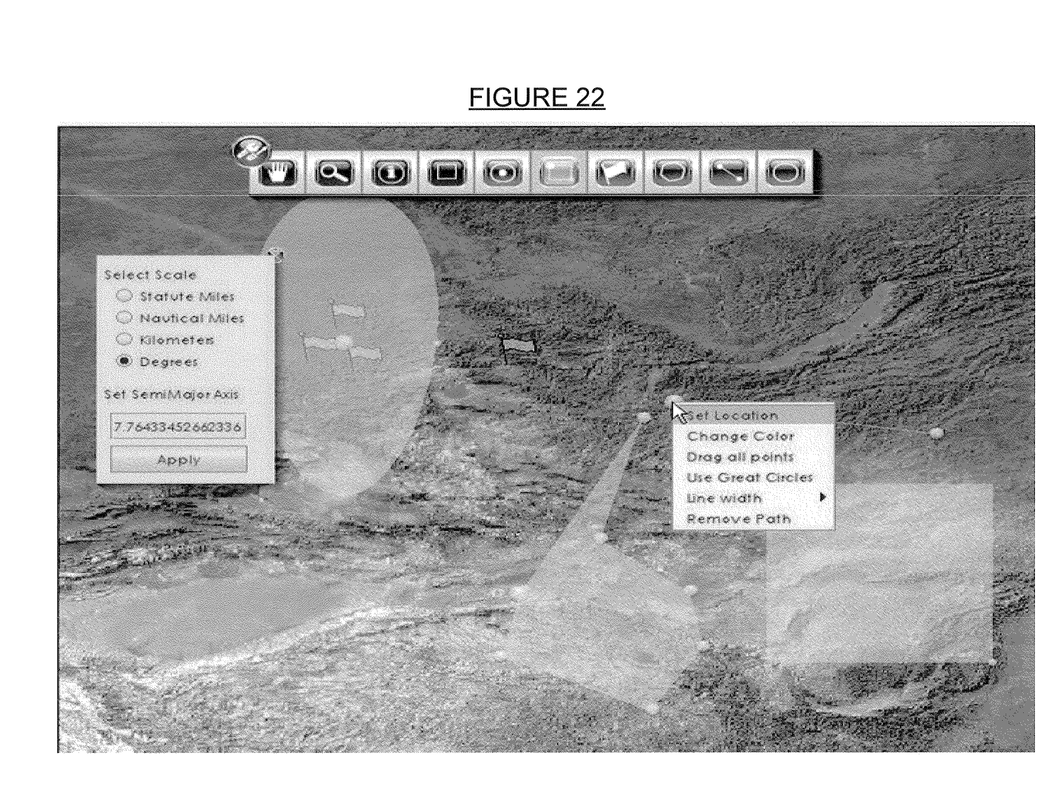

FIG. 2 illustrates examples of various widgets available to a user, according to one embodiment of the invention. The various widgets include, but are not limited to, preferences mouse coordinates 315, overview map 320, layers 330, reports 335, tools 325, map scale 326, place finder 327, bookmarks 329, and help 331. The tools include zoom in 340, zoom out 345, pan 340, information 355, estimate distance 360, add layers 365, and geometry tools 370 (e.g., radius 371, extent 372, line 373, polygon 374, ellipse 375 and flag 376). (See, for example, FIGS. 3-8E and 17-20 for examples of the widgets, and FIGS. 9A-10D and 21-28 for examples of the tools. FIG. 3 is a closer up view of the various widgets illustrated on FIG. 2, according to one embodiment).

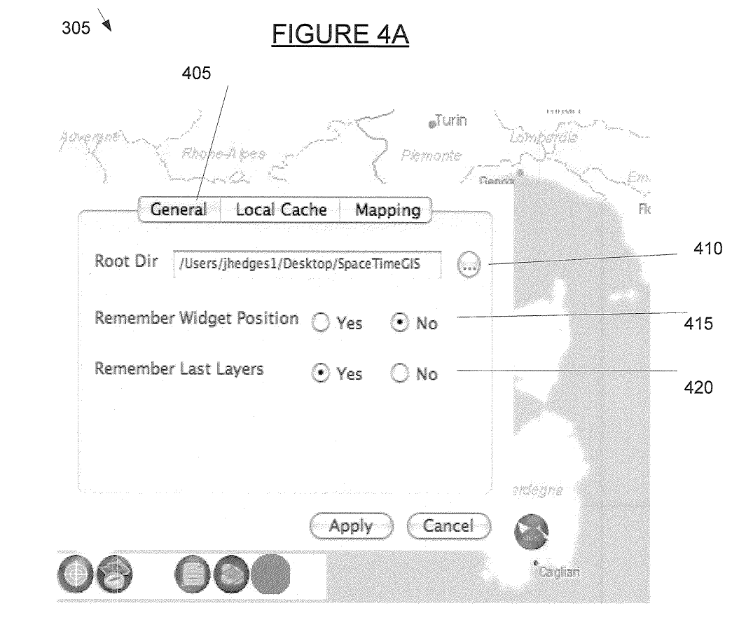

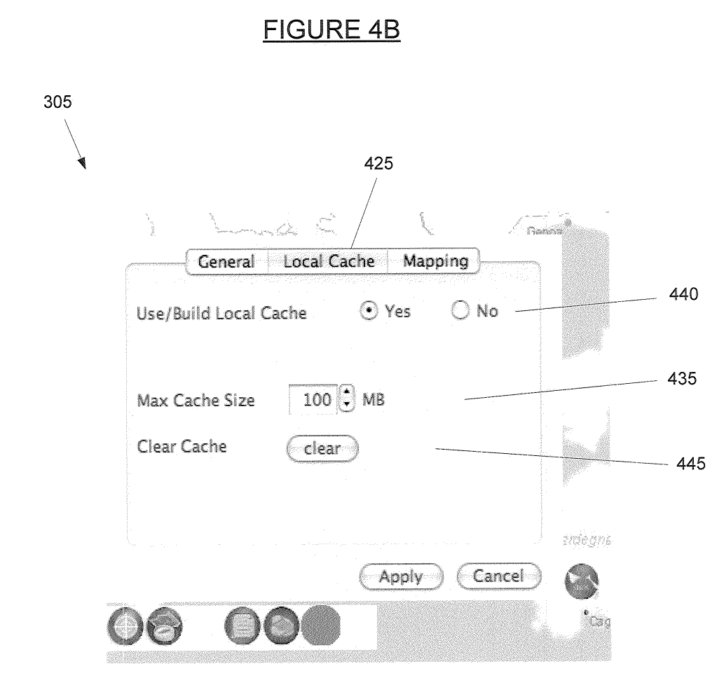

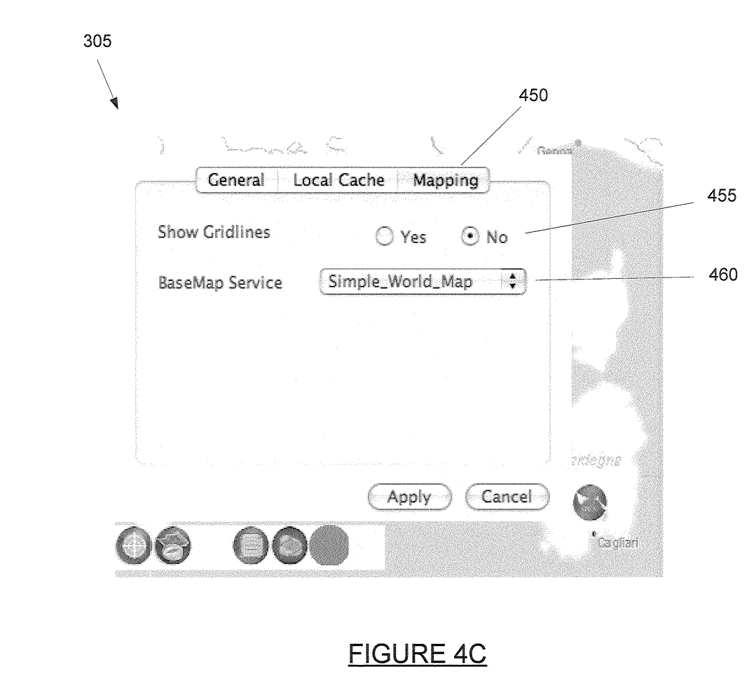

FIGS. 4A-4C illustrate options available when the preferences widget 305 is utilized, according to one embodiment of the invention. FIG. 4A is a general preferences tab 405. The general preferences tab 405 allows the user to set the root directory where all cache and other resource files are stored. The general preferences tab 405 is where all the resources are stored such as the local tile cache. Users can select to have widget positions 415 and layers 420 remembered as a matter of user preference. FIG. 4B is local cache tab 425. The local cache tab 425 gives users options for caching. Users can choose the max cache size 435, disable local caching 440, and clear their cache 445. The max cache size 435 sets the amount of memory that the application is allowed to use. Once that number is exceeded the tile that was used the least is deleted to make room for the new tile. If the user disables local caching 440, the tiles are always pulled directly from the server and never saved or retrieved from the local cache. The clear cache button 445 will delete all cache files and associated resource files. A user can start fresh with their local cache by using this feature. FIG. 3C illustrates a mapping tab 450, which allows users to choose their base map 460, and turn gridlines on and off 455. As noted earlier, any map could potentially be used as a base map. The user defines the base maps and generates the cache for the client.

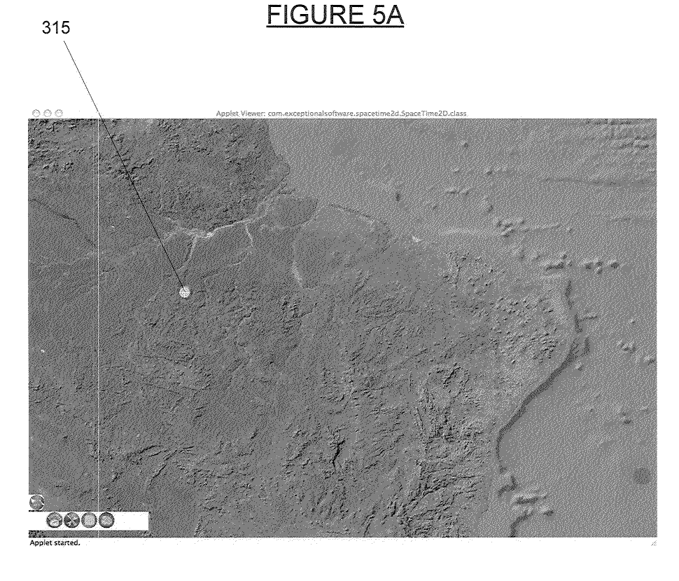

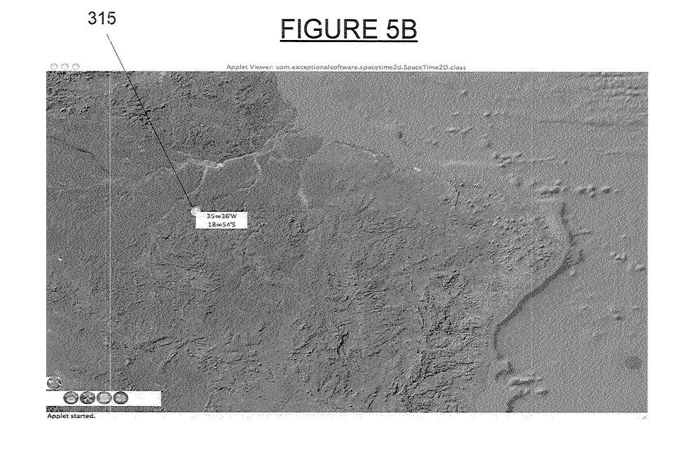

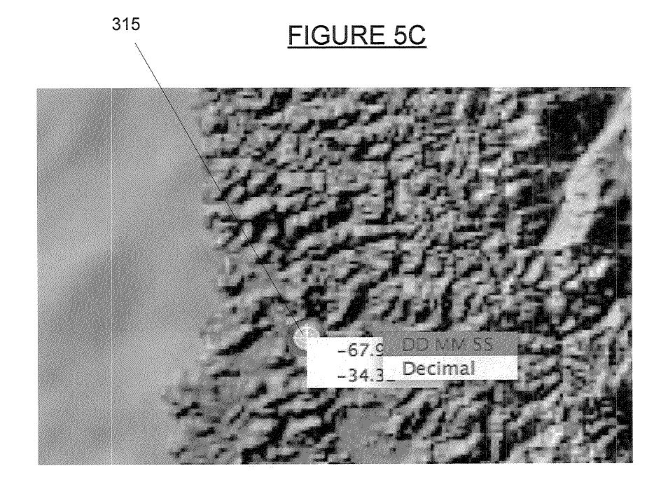

FIGS. 5A-5C illustrate options available when the mouse coordinates widget 315 is utilized, according to one embodiment of the invention. FIG. 12 is a flowchart illustrating how the mouse coordinates widget 315 operates, according to one embodiment of the invention. The mouse coordinate widget 315 shows the real world coordinates of the map as the mouse cursor moves over the map. In 1205, the mouse coordinate widget 315 is selected and dragged to the desired location on the map, as illustrated in FIG. 5A. In 1210, the user double-clicks on the mouse coordinate widget 315 to expand it. In 1215, a calculation is performed of the screen coordinates of the map to real world coordinates in decimal degrees (DD). This can be done by determining the height and width of the screen in pixels and the geographical extent of the screen. Then, we can determine the geographical unit that a pixel represents. So, if the screen is 1000 pixels wide and the viewing area is 100 degrees (distance between west and east) each pixel represents 0.1 degrees. So if a pixel is located 100 pixels from the left and the eastern extent is 22.5 degrees, that pixel would represent the longitude between 32.5 and 32.6 degrees This is illustrated in FIG. 5B. In 1220, the user can choose a degrees minutes seconds (DMS) format instead of a decimal degrees format. If so, a calculation from DD to DMS is performed, an example of which is displayed in FIG. 5C. The user can also select to display the mouse position in the upper right corner of the screen.

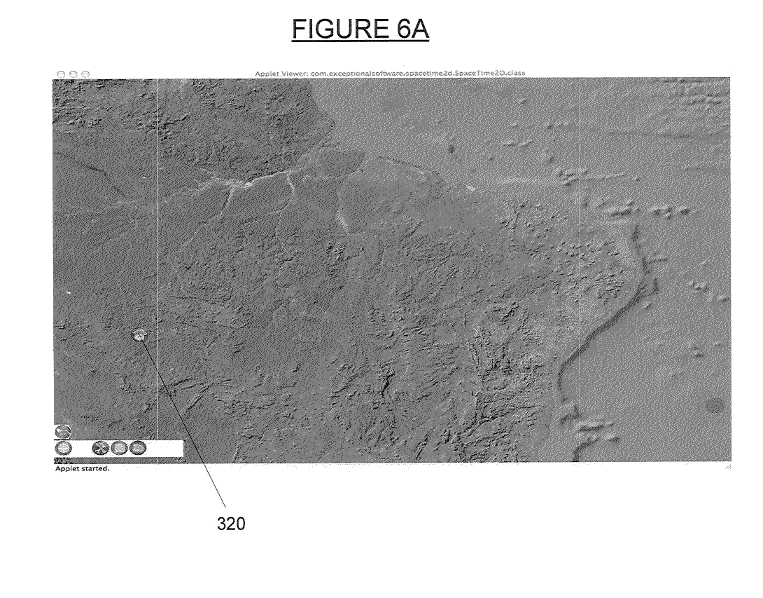

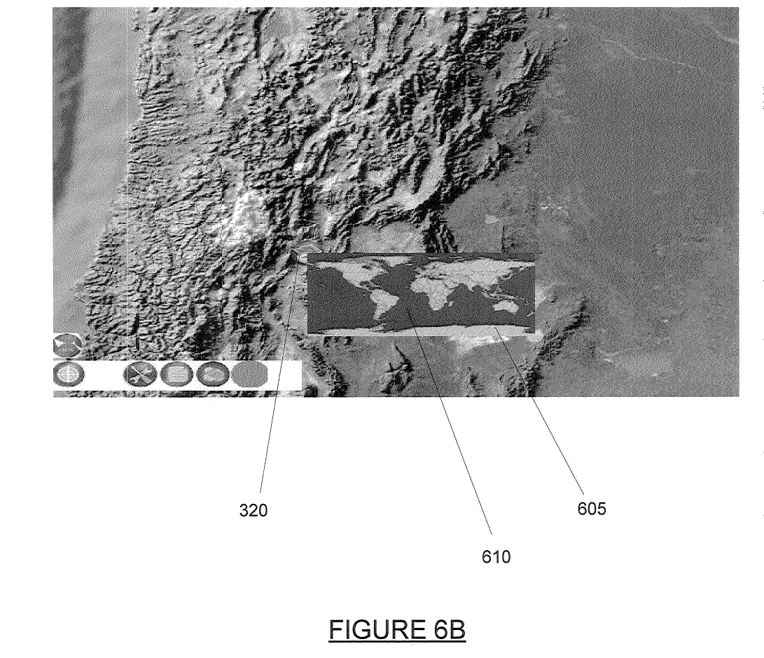

FIGS. 6A-6B illustrate options available when the overview map widget 320 is utilized, according to one embodiment of the invention. FIG. 13 is a flowchart illustrating how the overview map widget 320 operates, according to one embodiment of the invention. The overview map widget 320 provides a small graphical reference describing the user's span of view on the screen. It also allows the user to change the viewing area of the screen. In 1305, the overview map widget 320 is selected and dragged to the desired location on the map, as illustrated in FIG. 6A. In 1310, the user double-clicks on the overview map widget 320 to expand it. In 1315, the overview map widget draws a geographical bounding box (e.g., in red) outline 605 surrounding an overview map 610 from the real world coordinates of the viewable screen (which are stored internally) on a world map and illustrates that to the user, as shown in FIG. 6B. If the geographical bounding box is determined to be too small to see on the map, cross hairs (i.e., two intersecting lines) are used instead of box 605. In 1320, the user can click on any part of the overview map 610 to navigate directly to that area. For example, if the user were to click on Europe in the overview map, it would take them exactly where they clicked on Europe on the map at their current zoom level. Alternatively, in 1325, the user can drag box 605 on the overview map 610 to pan the screen viewing area around. The user may also use the bookmark widget to instantly go to an area of interest. For example, if the user drags the red extent box on the overview map, it will change the viewable extent to match the red extent box on the overview map.

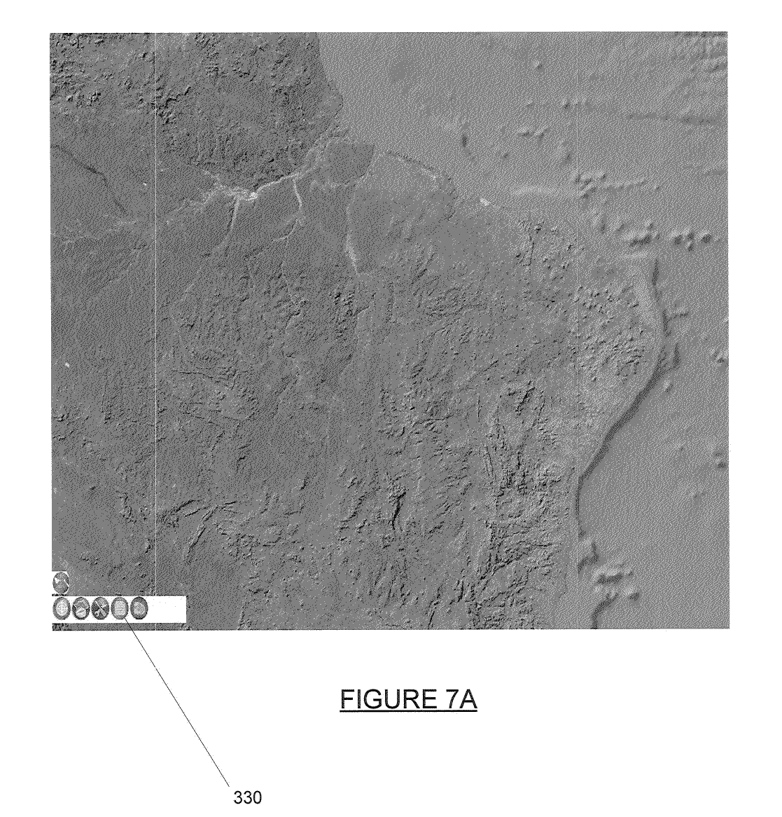

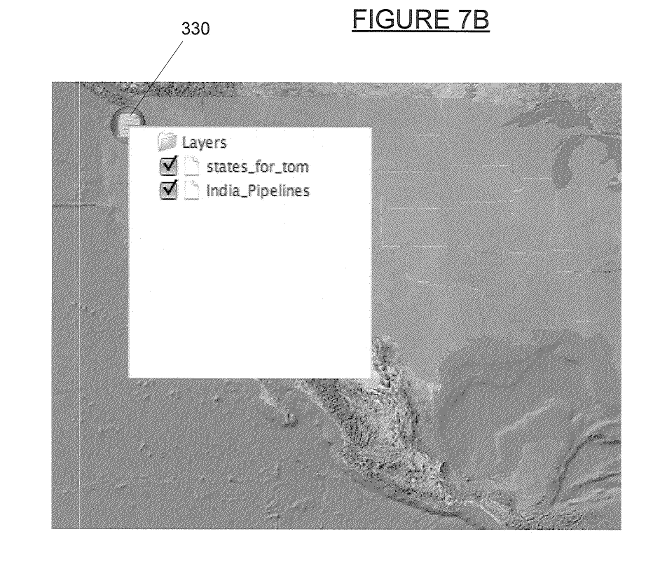

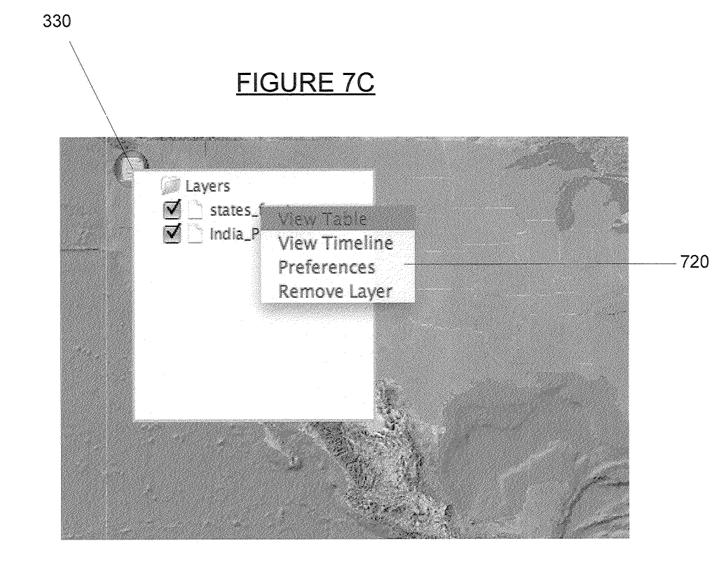

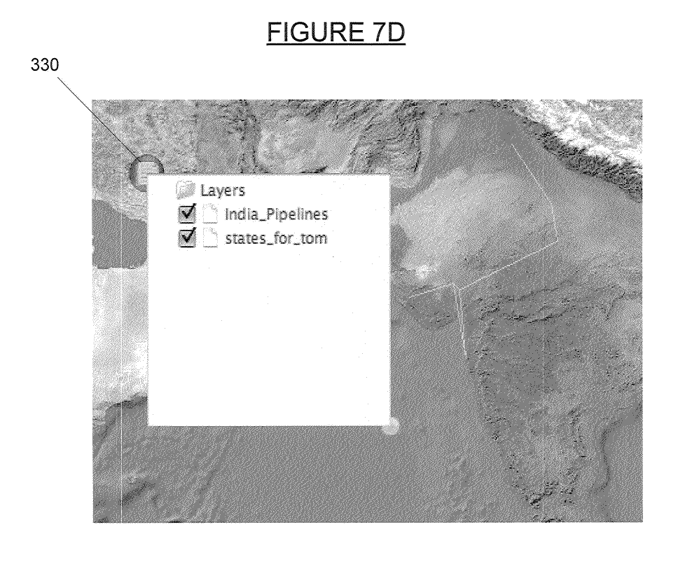

FIGS. 7A-7D illustrate options available when the layers widget 330 is utilized, according to one embodiment of the invention. FIG. 14 is a flowchart illustrating how the layers widget 330 operates, according to one embodiment of the invention. The layers widget 330 gives the user a way to interact with static and dynamic layers on a map. The layers are managed in the application using, e.g., Java's JLayeredPane. The vector layers added to the map are all drawn in a separate thread. This is done to enhance the performance of vector layers containing many records or many vertices. The thread generates an image where the main thread uses it to paint over the basemap drawn in its thread. For example, if a user were to add 3 vector layers, they would all be drawn in the same thread but separate from the main thread. The three layers would be drawn in memory by this separate thread and, once complete, the main thread would place the drawn memory over the basemap drawn in the main thread. This could allow the application to draw more geometries faster. In 1405, the layers widget 330 is selected and dragged to the desired location on the map, as illustrated in FIG. 7A. In 1410, the user double-clicks on the layers widget 330 to expand it. In 1415, the user can toggle the layer as hidden or visible by checking or unchecking the checkbox next to its name, as illustrated in FIG. 7B. The layers that are imported from the server can be set to visible or invisible by checking or un-checking the box next to the layer name. Thus, for example, if the states layer were to be unchecked, the data associated with it would disappear from the map (the states). Likewise, if it were then checked it would reappear. In 1420, if a user right clicks on the layer name, a menu 720 appears, as illustrated in FIG. 7C. Menu 720 allows the user to view the table, view the timeline, set preferences (e.g., size of point/line), remove the layer, or set labels. For example, if a user added a layer to the map of all the airports in the United States and in the attribute data the name of each airport was specified, the user could specify that all geometries should be labeled by the airport name. Once the application iterates through all the names and generates labels, they can be placed on the screen near the geometry. The timeline to the map controls the objects viewed in the layer on the map based on the time span selected. For example, if a layer has temporal data that was identified the user can select to add a timeline over the map. On the time line appears a selection area that can be expanded an contracted and moved. It is a graphical range of time. As the selection is modified, the layer displays the elements that fall within the date. The geometries can be pre-indexed by date to ensure quick find and draw times. The user can thus view associated data or control a layer by right clicking and selecting the appropriate menu item. For example, if the user selects “remove layer” the entire layer and its associated data is deleted from the map and layer list. The user may then select to view the data associated with the layer or to remove the layer. In 1425, the user can drag a layer up and down in the list to change the order of the map layers, as illustrated in FIG. 7D, where the order for layers for the pipeline map and States have been changed compared to the order in FIG. 7B. The user can also choose to color the data based on an attribute. For example, hurricane line tracks could be colored by wind speed. The user can select that hurricanes be colored this way by selecting the set color option on the layer. The user can then specify the range of colors and the attribute that should determine the color. So if the user chooses wind speed and the low range color is blue and the high range color is red, all the most powerful hurricane tracks would be red and the weakest blue. All others could be a combination of the colors. If the user desires, they may have the application auto generate a legend to display what the colors signify.

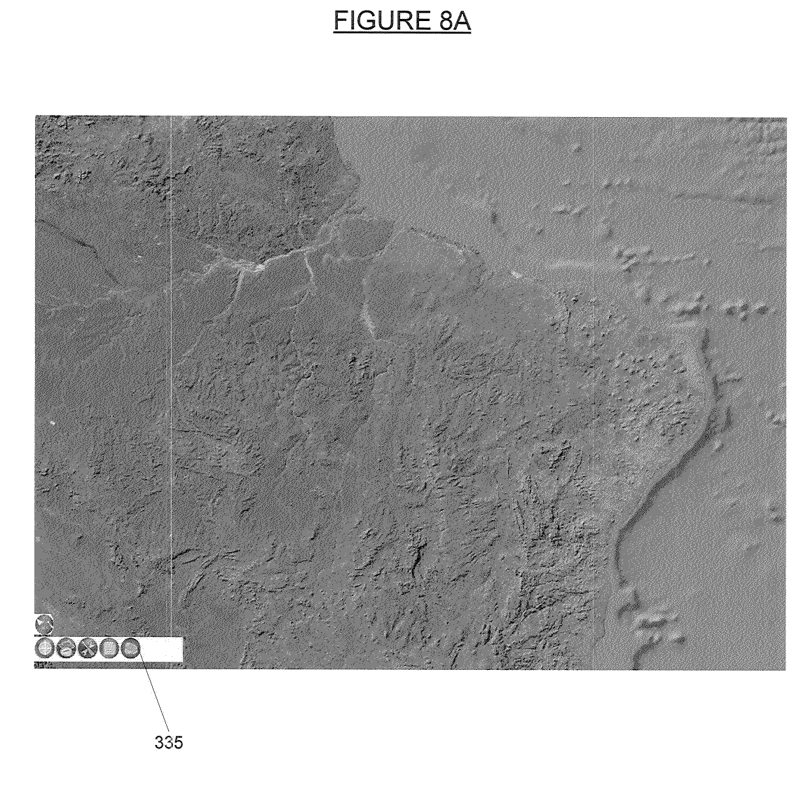

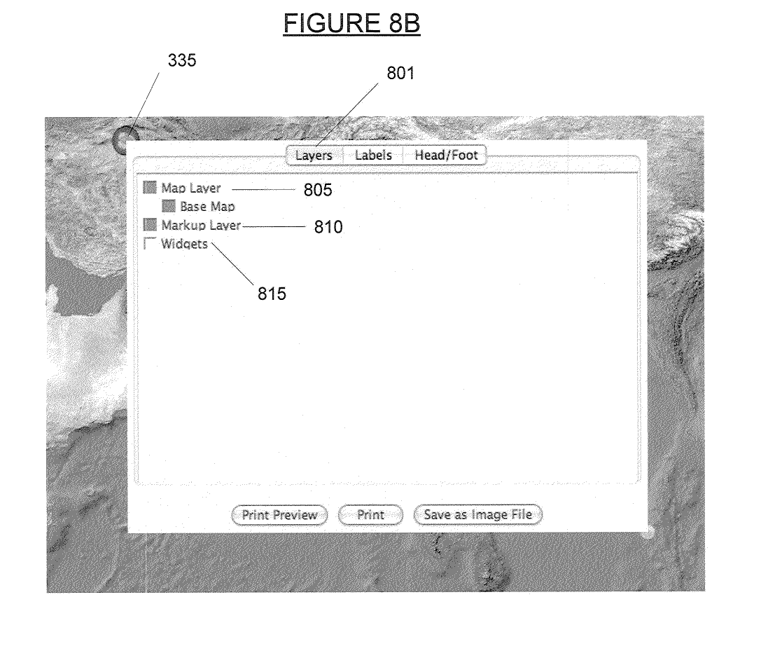

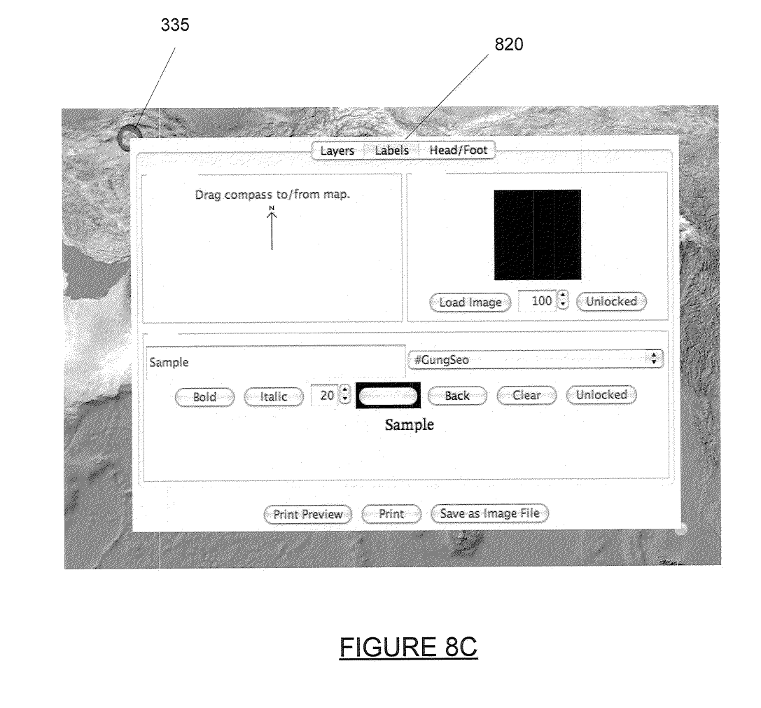

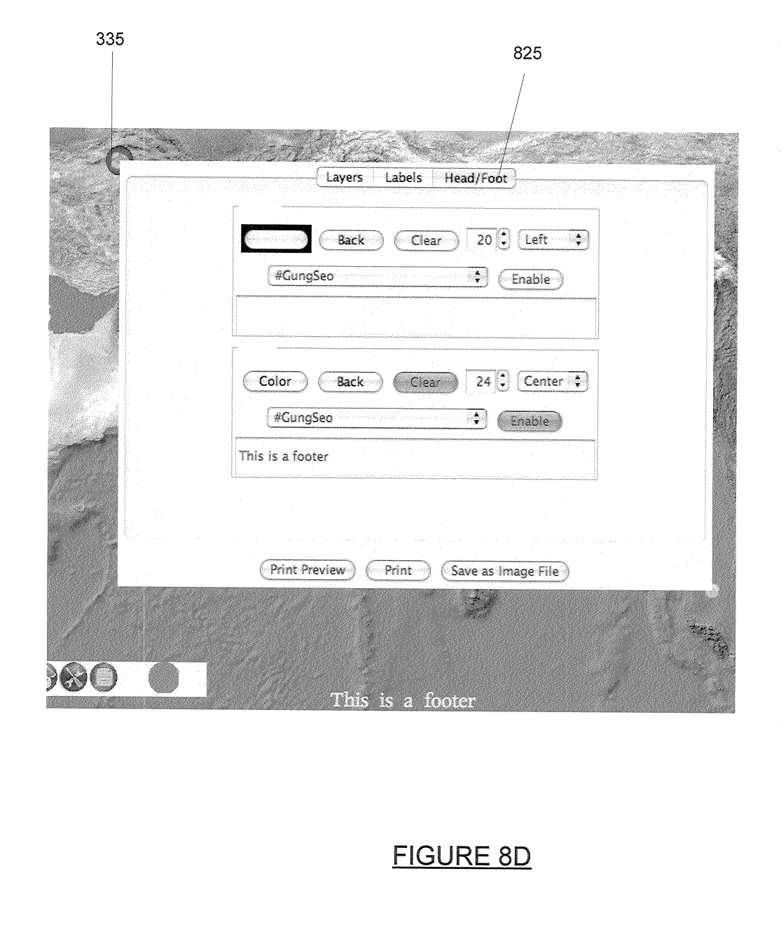

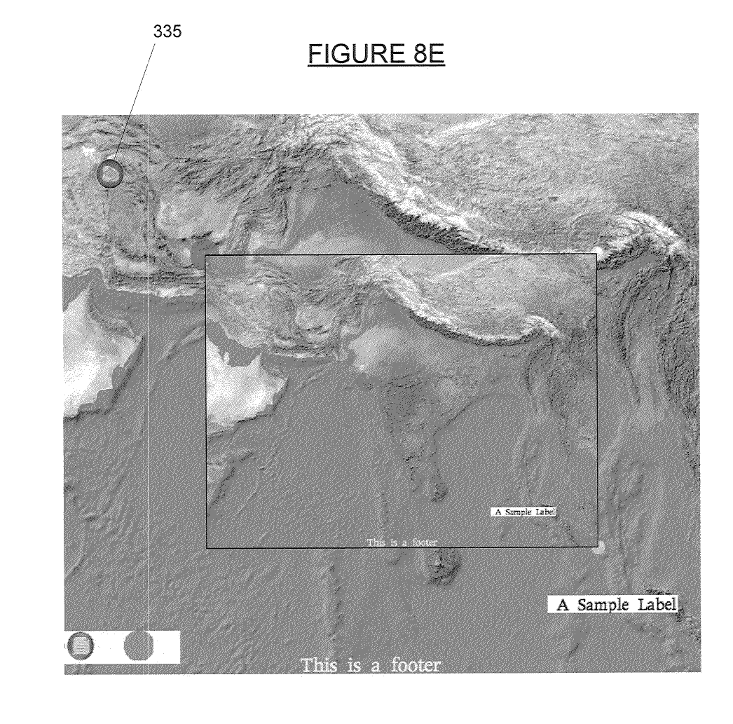

FIGS. 8A-8E illustrate options available when the report widget 335 is utilized, according to one embodiment of the invention. FIG. 15 is a flowchart illustrating how the report widget 335 operates, according to one embodiment of the invention. The report widget can enable users to generate, print, and export reports. In 1505, the report widget 330 can be selected and dragged to the desired location on the map, as illustrated in FIG. 8A. In 1510, the user can double-click on the report widget 335 to expand it. In 1515, the user can choose the graphical layers 801 that they wish to include in the report. As illustrated in FIG. 8B, the layers 801 are broken into three categories: the map layer 805, the markup layer 810, and the widget layer 815. The base map can be the actual map that is shown at the bottommost layer. It can be the map that is displayed from the tiles sent from the server. The map layer 805, markup layer 810, and widget layer 815 are internal layers used in the client to render the screen an order the user prefers. All map components can go into the map layer 805. Any labels or pop ups can go into the markup layer 810. The widget layer 815 houses all the widgets. In the context of the report widget, the layers show components that can be made visible on a report. The user can also add labels 820, such as a compass, labels, images, or a header and footer. The labels and images can be created in the widget and then they can be dragged out onto the map where they can be locked to world coordinates or screen coordinates. FIG. 8C shows the label section 820 of the report widget. A user can add text, a compass, or an image as a label. FIG. 8D shows the header and footer section 825 that allows the user to put them on the screen and the report. FIG. 8E illustrates how a footer would appear. Once the user has marked the map as desired, they can preview the report, export it to an image, or print it.

FIG. 17 also illustrates a report widget 335, according to one embodiment. FIG. 17 shows custom labels being created and then dragged onto the map. This interface is also used to load images into the application and drag them onto the map in a similar fashion. The user can the click the button “Print Preview” to view what would be printable and then save it as an image or print the map.

FIG. 18 illustrates options available when the map scale widget 326 is used. The map scale widget shows the distance on the screen that represents the distance on the map. As the widget is dragged to different locations on the screen or the user zooms into the map, the map scale adjusts to show the correct representation of distance.

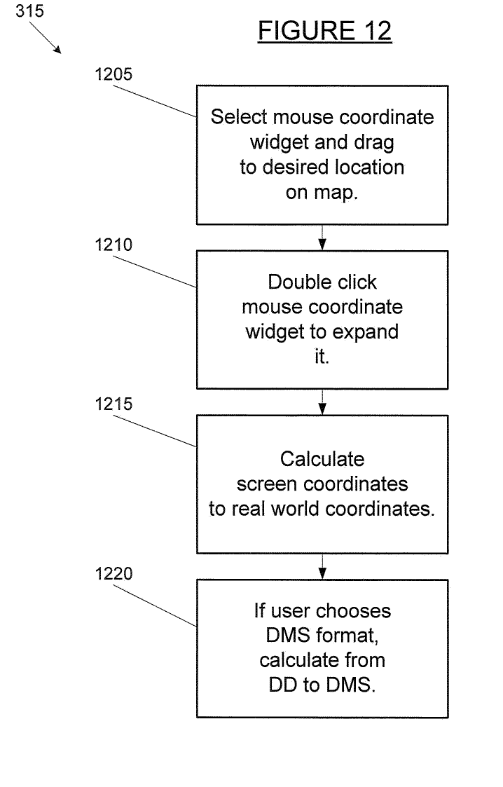

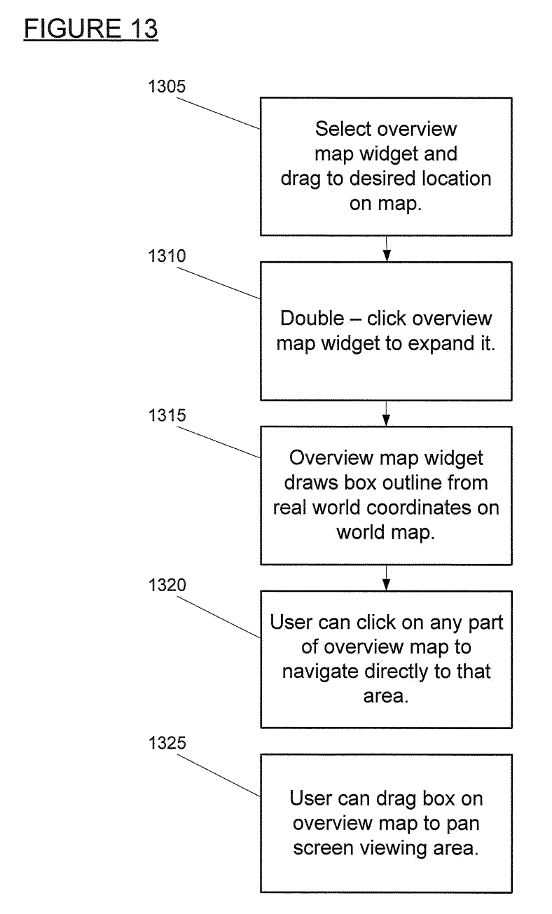

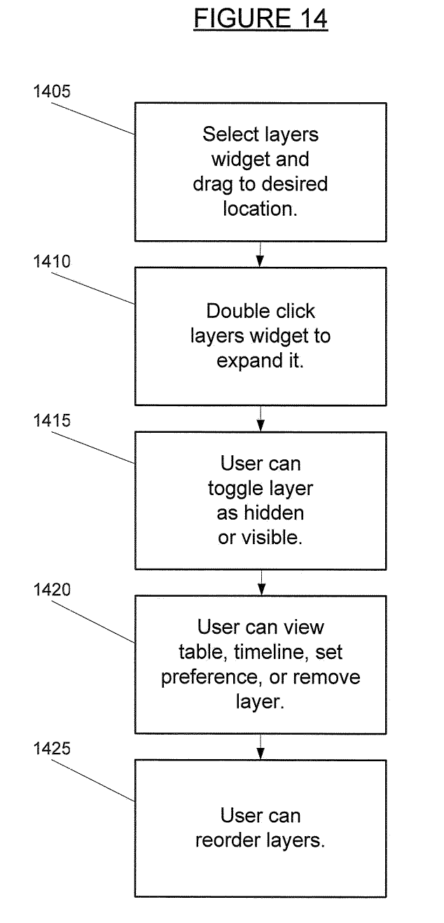

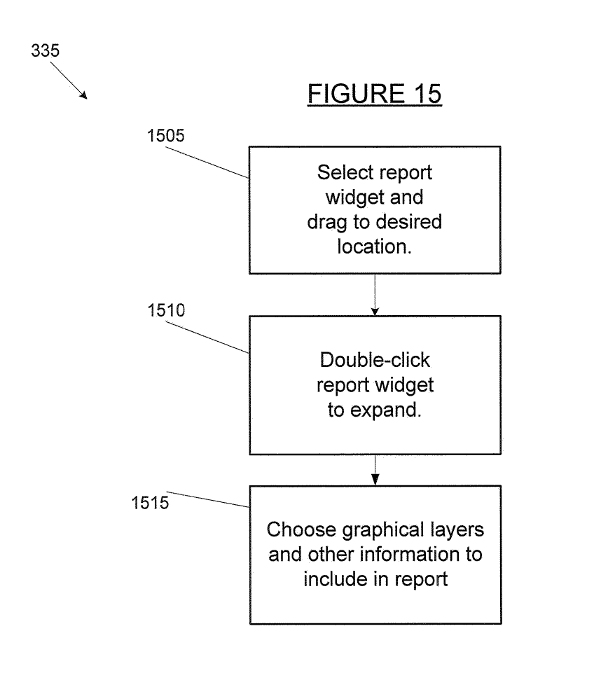

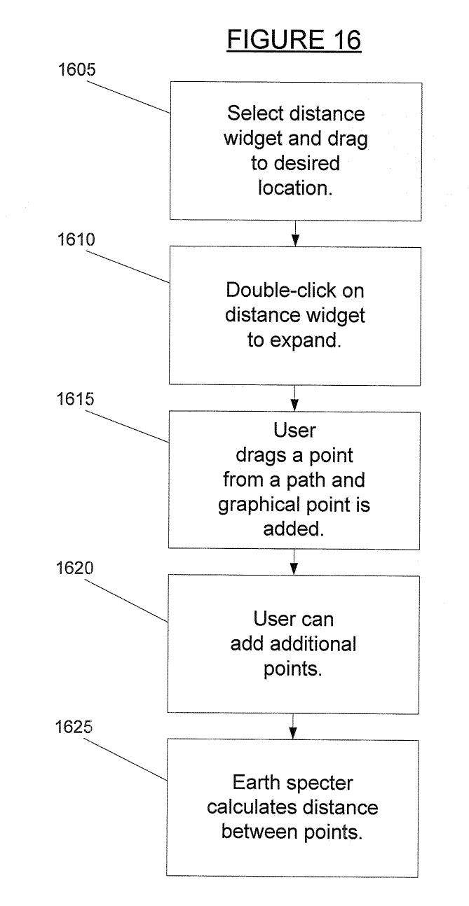

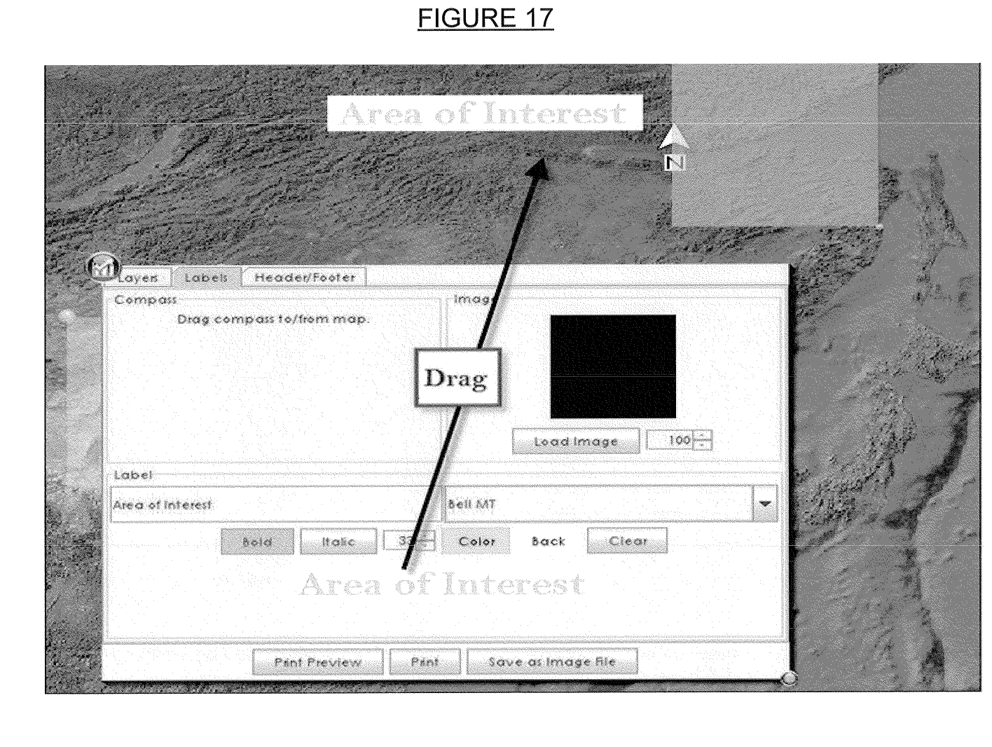

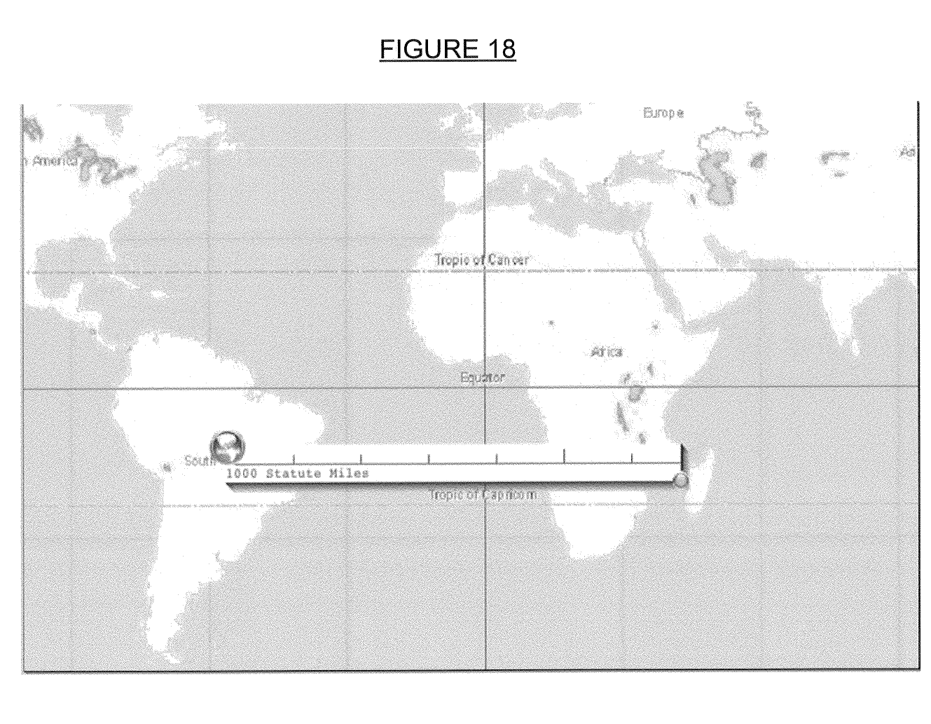

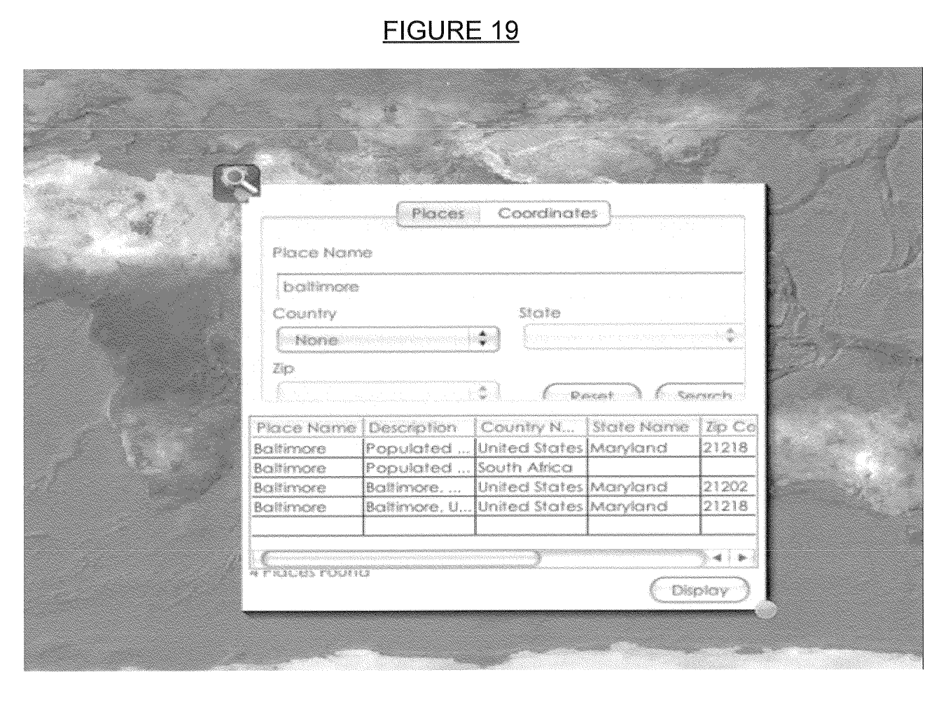

FIG. 19 illustrates options available when the placefinder widget 327 is utilized, according to one embodiment. The placefinder widget 327 allows user to type in the name of a place, see the results listed, and put the selected places on the map. The user can perform a spatial query on an area and obtain all results within that area from the database. Alternatively, the user can query an area such as “Baltimore” and see the results. Administrators can add data to the database on the server to expand the dataset available. For example, if an administrator had a database of known areas, they can be imported into the placefinder database and then be searchable by the user.

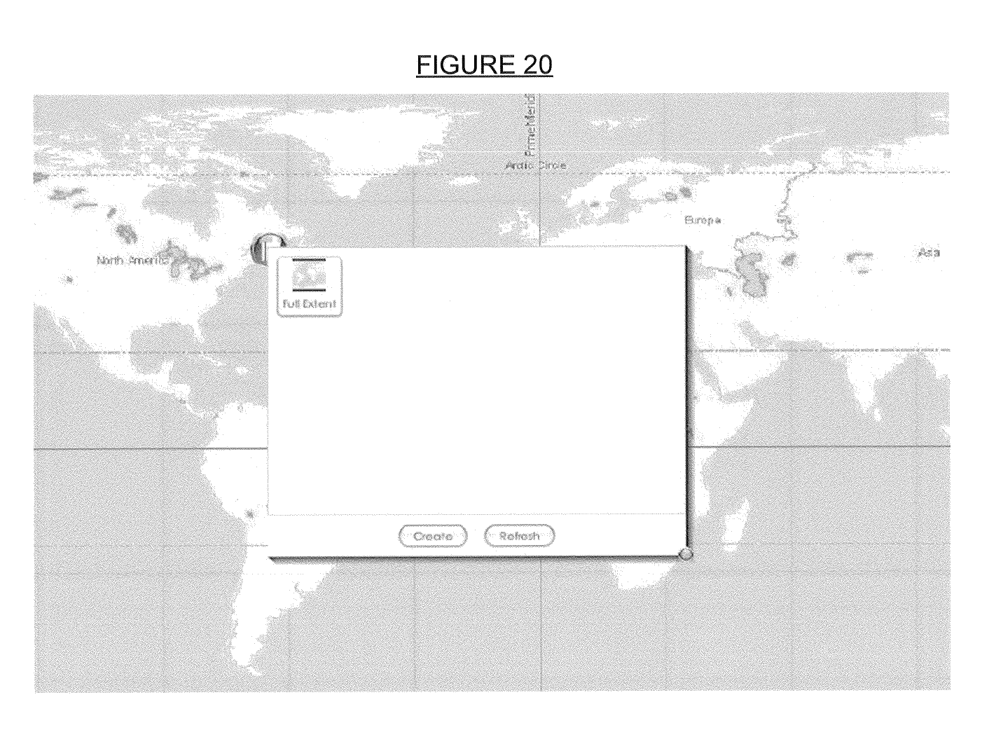

FIG. 20 illustrates options available when the bookmarks widget 329 is utilized, according to one embodiment. The bookmarks widget 329 allows users to save areas of interest so that they can quickly navigate to those areas. The user goes to an area of the map that they are interested in, opens the bookmarks widget and clicks add. The user will then name the bookmark and save it. It is saved in the user's local cache. The bookmark appears as an icon of the area (a screenshot) and the name. Once clicked, it will take the user directly back to that area of the map. So if a user frequents the north part of San Diego they can add a bookmark to the exact northern part of San Diego that they are interested in. Once they navigate away from that area, they can return by clicking on the bookmark.

FIGS. 9A-9E illustrate options available when the tools widget 325 is utilized, according to one embodiment of the invention. The tools widget 325 of FIG. 9A allows the user to interact with the map by zooming, panning, adding data, and identifying objects. The tools include zoom in 340, zoom out 345, pan 340, information 355, estimate distance 361, add layers 365, and geometry tools 370 (e.g., radius 371, extent 372, line 373, polygon 374, ellipse 375 and flag 376). The zoom in widget 340/zoom out widget 345 changes the mouse mode to zoom by selecting a region with a bounding box, as illustrated in FIG. 9C. The box that is drawn on the screen does an XOR on the colors of the map so that the selection is always the opposite color. If the user drags a selection from the upper left to the lower right, the selected area is zoomed into. If the user drags a selection from the lower right to the upper right, the entire screen is put into the size of the box (zoomed out). For example, if a user begins a drag and then moves it from the bottom to the top left 300×300 pixels, it zooms the map out so that the total original extent fits into a box 3×3 pixels.

The pan tool 340 allows the user to drag the map all around the screen, as illustrated in FIG. 9B. If the user desires to zoom in while in pan mode, it may be accomplished by using a scroll wheel.

The information tool 355 allows the user to identify an object that is part of a layer, as illustrated in FIG. 9D. Once identified, an id tag will pop up with html in the content window and anchored to the object. An administrator can customize the html inside the id window by using a server configuration tool. On the server exists a popup window generator. The administrator can put in custom html to make the popup template look a certain way or add attributes of the data. If the administrator adds the syntax “[ID=0]” it would replace the text with the data for the geometry located at that zero based index.

The add layer tool 365 adds layers of other maps from the server onto the basemap, as illustrated in FIG. 9E. The maps can be maps of geography (countries, states, world, etc.) or maps of information (pipelines, roads, rivers, etc.). Once pressed a dialog will appear. The user can select the desired service(s) and click the add button. Upon which, they will be added as separate layers on the map. The user can also select to import a file on their local system to be added to the map. The user may select any valid Shapefile or KML file. The client then send the file(s) to the server. The server converts them to STML and sends them back to the client where it is displayed as one or more layers. For example, if a user selects to import a shapefile called towns, the application looks for files: towns.shp, towns.shx, towns.prj, and towns.dbf (these are the minimum files required for a shapefile). The files are zipped and sent to the server. The server unzips and temporarily stores the files. The server then parses the shapefile and converts geometries and attribute data to STML. The STML is sent back to the client which causes the data to be displayed. Thus the user is able to view all the towns that were in the file.

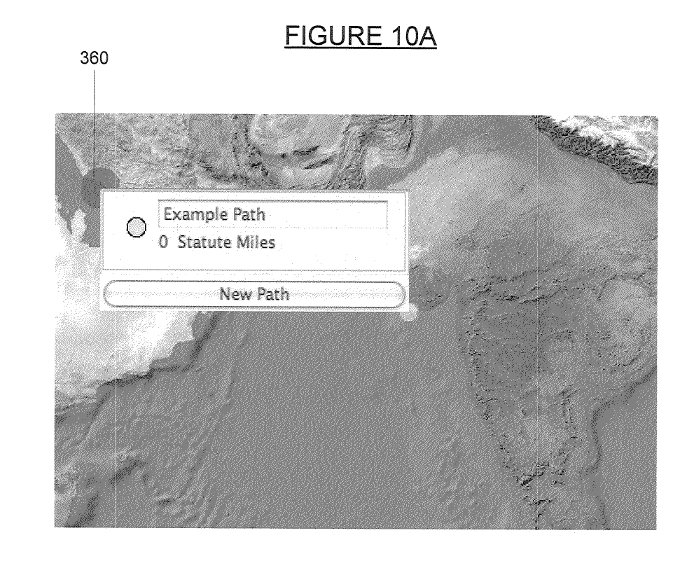

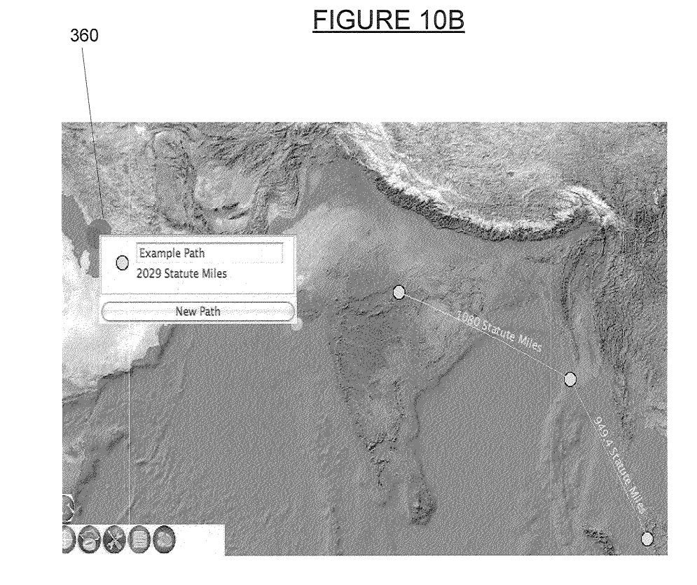

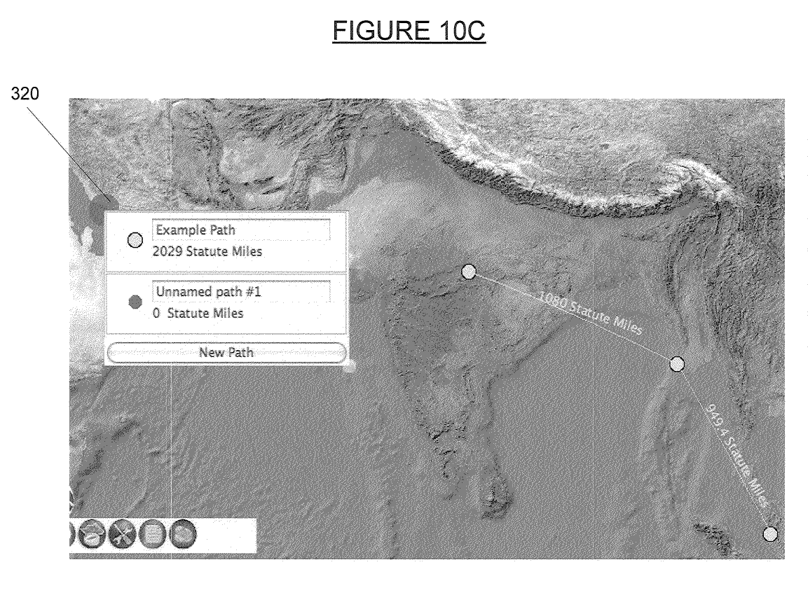

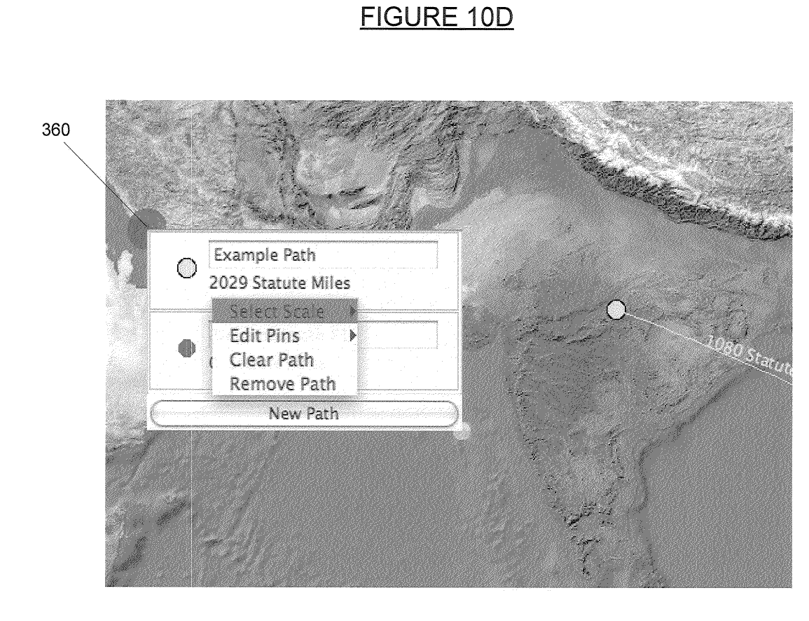

FIGS. 10A-10E illustrate options available when the estimate distance tool 360 is utilized, according to one embodiment of the invention. FIG. 16 is a flowchart illustrating how the distance widget 360 operates, according to one embodiment of the invention. The distance widget 360 allows users to measure a series of distances individually and/or as a total. In 1605, the estimate distance widget 360 is selected and dragged to the desired location on the map, as illustrated in FIG. 10A. In 1610, the user can double-click on the report widget 335 to expand it, as illustrated in FIG. 10B. The user can name the new path, if desired. In 1615, as illustrated in FIG. 10C, the user need only drag a point from a path as shown below and a graphical point is added to the display layer of the application. In 1620, the user can add additional paths by clicking new path in FIG. 10D. If more than one point is added a line is drawn between the last point and the new point. The line that is drawn represents the shortest path between the points. Because of shape of the earth, the line is not straight. In 1625, as also illustrated in FIG. 10D, the distance between the graphic points is calculated and a line is drawn to represent the path. In 1625, as illustrated by the menu in FIG. 10E, the user can customize the paths by changing the shape of the pins, their color, or the scale of the path. The scale is the units in which the map is shown (kilometers, miles, etc). The pins can be edited by changing the color or setting the size. By clearing the path, a user can reset the distance path to blank and start new. The remove path option removes the path layer entirely from the map and widget. As illustrated in FIGS. 10B-10E, the user can also add multiple paths and name them for use in the report widget.

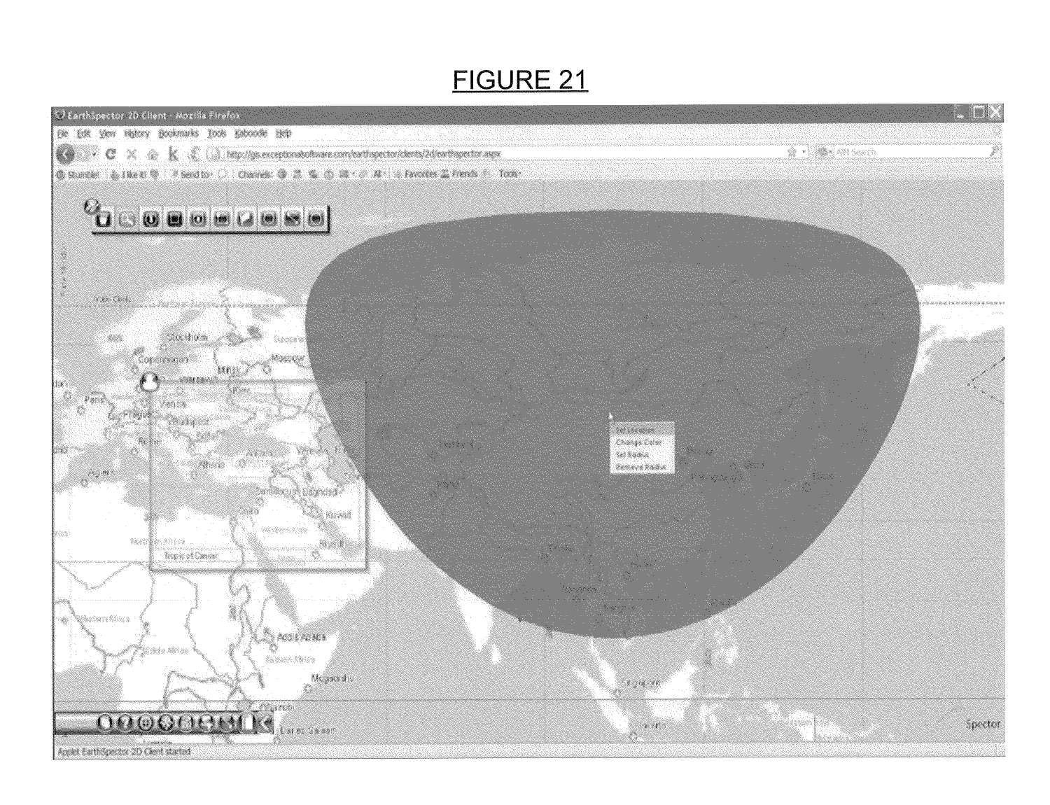

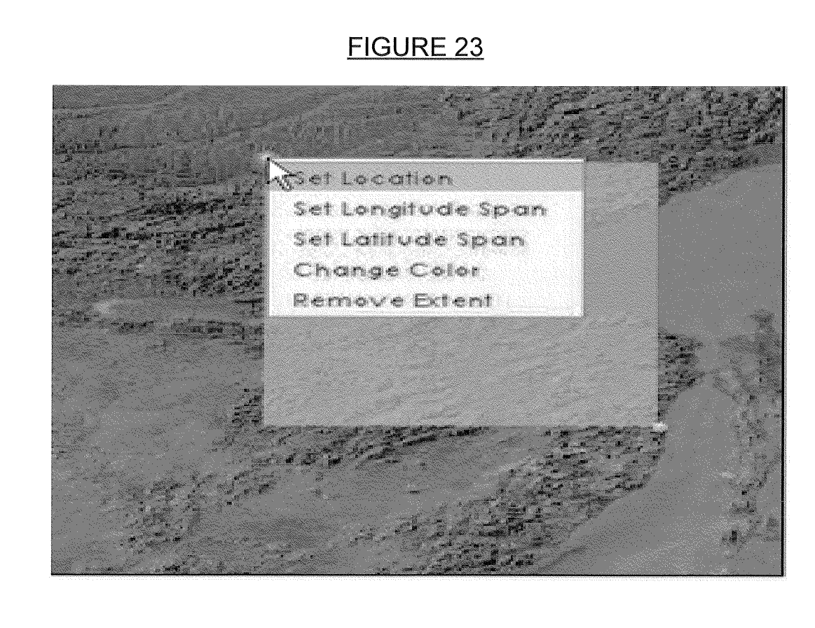

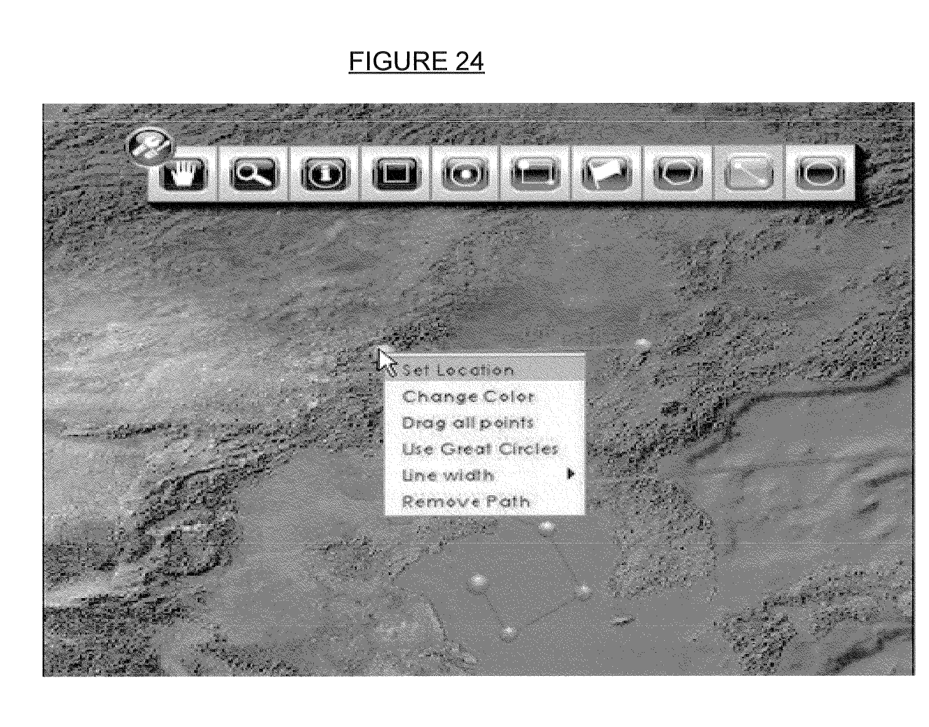

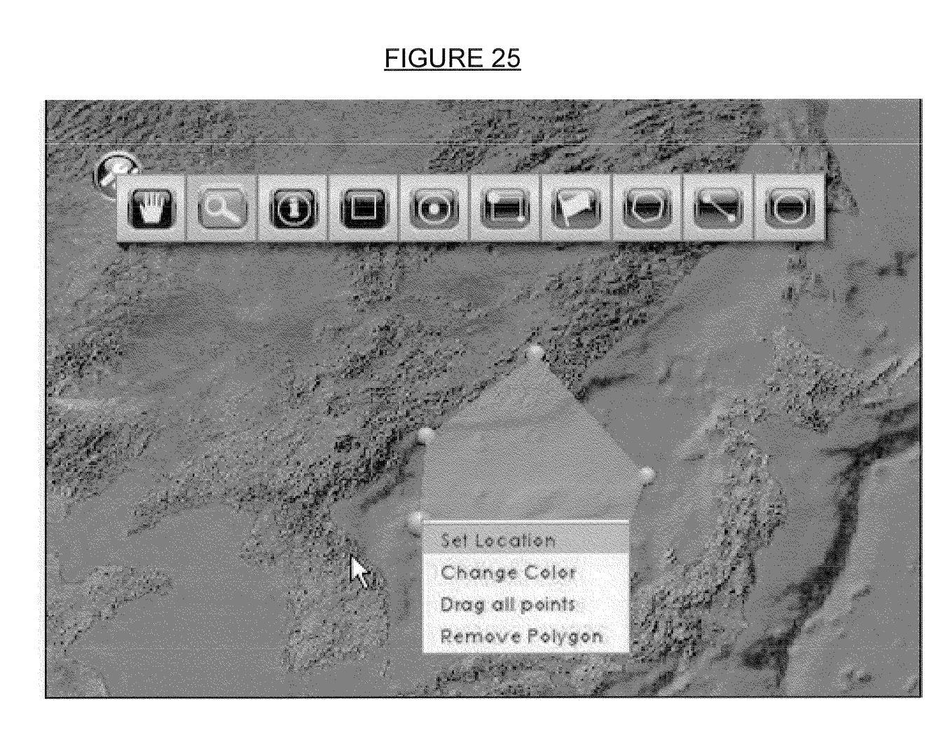

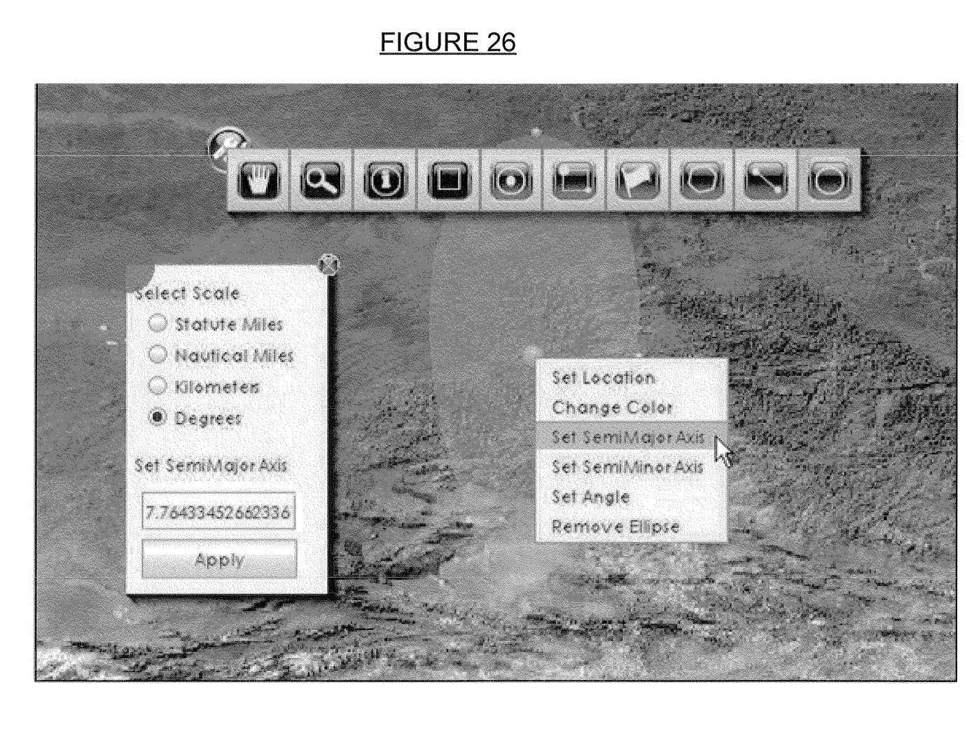

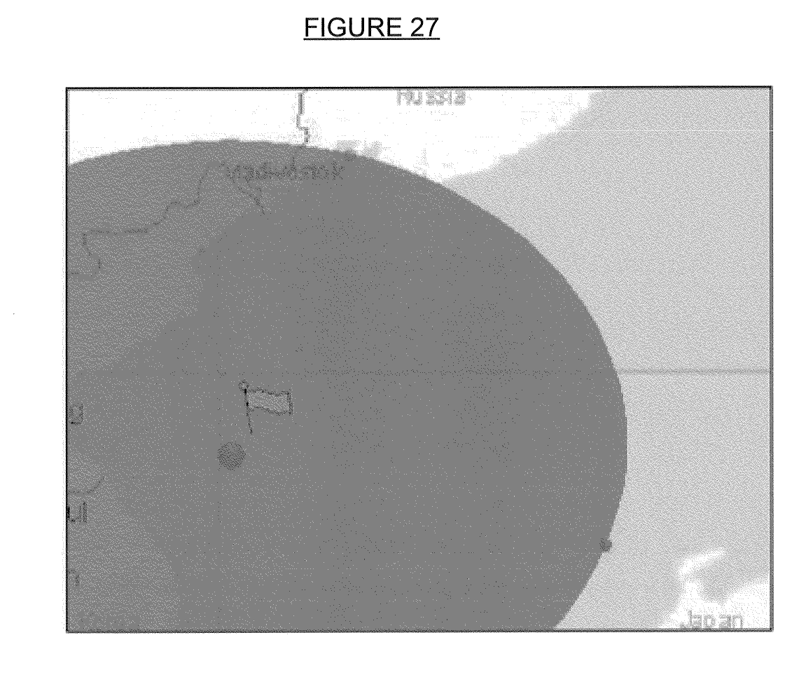

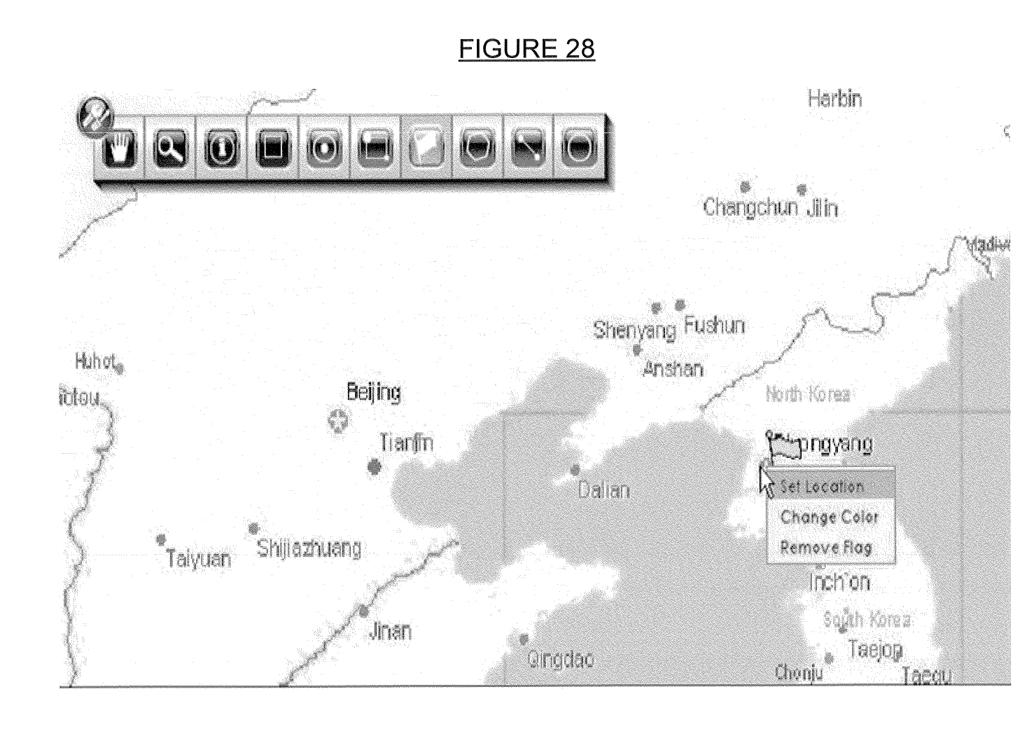

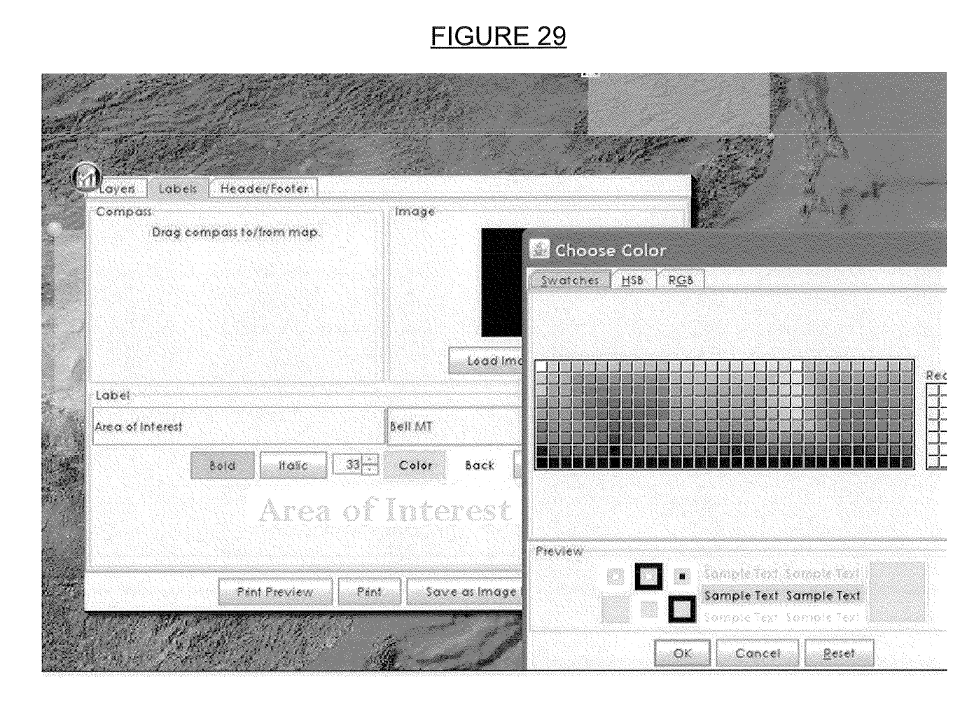

FIGS. 21-28 illustrate the geometry tools (radius 371, extent 372, line 373, polygon 374, ellipse 375, and flag 377) draw shapes on a map. The shapes can be used as part of a selection or used to author vector layers on the map. The radius tool 371 (illustrated in FIG. 21) can draw a radius of a user specified distance anywhere on the map. Since the earth is projected onto a 2 dimensional surface, a radius appears much different at the equator than it does at the poles. At the equator it is close to a perfect circle. At the poles the radius appears as a rectangle at the top of the screen. FIG. 21 shows a radius on the map. Notice that this radius is not a circle because it is being projected onto the map to represent equal distance from center point to outer edge. By right clicking the radius a menu appears to set its attributes manually. The extent tool 372 (illustrated in FIG. 23) can draw a box around north, south, east, and west coordinates. The box can be user specified or the user can use the tool to select the area graphically on the map. The large point on the box can be used to move the box and the smaller point is used to resize it. The box can be dragged anywhere on the map and will always appear semitransparent. If the user right clicks on the largest point they can manually set the location and color of the box. The line tool 373 (illustrated in FIG. 24) simply draws lines on the map. It can draw single or multiple segmented lines. As with the extent, the lines can be user specified or set graphically by dragging them on the map. FIG. 24 shows the line tool with multiple line segments. The largest point in the line will move the entire line. Also, if one were to right click on the largest point a menu will appear that will allow the user to set parameters for the line manually. One of the options, “Use Great Circles”, allows the user to use the shortest path between points in a line. The polygon tool 374 (illustrated in FIG. 25) draws a polygon on the map. The points of the polygon can only be set graphically by the user double clicking where they would like the vertices to be placed. FIG. 25 shows the polygon tool. The largest point in the polygon will move the polygon as a whole. Also if the user right clicks on the largest point they are presented with a pop up menu that allows them to set parameters of the polygon such as color and location of points. The ellipse tool 375 (illustrated in FIG. 26) draws an ellipse any where on the map by using a user specified semi-major axis, semi-minor axis, and center point. The user can set these values or change them graphically by adjusting the shape. As with the radius tool, the ellipse appears differently on a projected map at the equator and the poles. FIG. 26 shows the ellipse tool. The user can adjust the semi major and semi minor axis by dragging the small dots on the outside of the ellipse. The large dot in the center of the ellipse allows the user to move the shape. Also, if the user right clicks on the center point a small popup menu appears where parameters for the ellipse may be set. The units for each axis can be set to a unit familiar to the user as shown in FIG. 26. The flag tool 376 is illustrated in FIGS. 27 and 28. The flag tool allows a user to flag an existing geometry. This will cause the existing geometry to be part of the selection or duplicated if desired. The user must only place the flag over the polygon or line and it will become selected. FIG. 27 demonstrates a shape being flagged. FIG. 28 shows that a flag can be right clicked and manually placed at certain coordinates, removed, or have its color changed. FIG. 29 illustrates features that can be customized by a user.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. Tile disclosed architecture is sufficiently flexible and configurable, such that it may be utilized in ways other than that shown. For example, the steps listed in any flowchart may be re-ordered or only optionally used in some embodiments. As another example, more than two data sets could be used in each analysis.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method for providing at least one map of geographical data, comprising:
connecting at least one client to at least one server utilizing at least one Web browser;
accepting at least one request from the at least one client of at least one geographical viewing area of at least one desired basemap;
searching at least one server directory for at least one list of tiles corresponding to the at least one geographical viewing area of the at least one desired basemap;
returning to the at least one client the at least one list of tiles enabling the at least one client to determine if any of the at least one tiles are in at least one local cache;
generating any tiles in the at least one local cache from the at least one local cache; and
generating any tiles not in the at least one local cache from the at least one server;
wherein the tiles generate at least one map of at least two dimensions; and wherein all communication between the at least one server and the at least one client is done utilizing STML.

2. The method of claim 1, wherein the date and time a tile was created helps the at least one client determine if a tile on the at least one server is more recent than a tile in the at least one cache.

3. The method of claim 1, wherein widgets are utilized to enable at least one user to discover information and/or customize the at least one map.

4. The method of claim 1, wherein at least one user is able to view multiple vector data sets shown together as different layers on the at least one map and wherein at least one user can change representation of vector data based on their attributes.

5. The method of claim 1, wherein the at least one server can identify standard date formats in at least one record and enable the at least one client to display all data results within at least one user selected timeframe.

6. The method of claim 1, wherein at least one user is able to manipulate the at least one base map and vector data sets into at least one visual representation needed and then publish at least one report.

7. The method of claim 1, wherein the at least one user is able to prepare at least one map illustrating information to be saved in the at least one local cache for future use.

8. The method of claim 1, wherein the tiles generate at least one base map that is the bottom most layer and all other layers are placed upon that bottom most layer.

9. A system for providing at least one map of geographical data, the system comprising:
at least one server coupled to at least one network;
at least one user terminal coupled to the at least one network;
at least one application coupled to the at least one server and/or the at least one user terminal, wherein the at least one application is configured for:
connecting at least one client to at least one server utilizing at least one Web browser;
accepting at least one request from the at least one client of at least one geographical viewing area of at least one desired basemap;
searching at least one server directory for at least one list of tiles corresponding to the at least one geographical viewing area of the at least one desired basemap;
returning to the at least one client the at least one list of tiles enabling the at least one client to determine if any of the at least one tiles are in at least one local cache;
generating any tiles in the at least one local cache from the at least one local cache; and
generating any tiles not in the at least one local cache from the at least one server;
wherein the tiles generate at least one map of at least two dimensions; and wherein all communication between the at least one server and the at least one client is done utilizing STML.

10. The system of claim 9, wherein the date and time a tile was created helps the at least one client determine if a tile on the at least one server is more recent than a tile in the at least one cache.

11. The system of claim 9, wherein widgets are utilized to enable at least one user to discover information and/or customize the at least one map.

12. The system of claim 9, wherein at least one user is able to view multiple vector data sets shown together as different layers on the at least one map and wherein at least one user can change representation of vector data based on their attributes.

13. The system of claim 9, wherein the at least one server can identify standard date formats in at least one record and enable the at least one client to display all data results within at least one user selected timeframe.

14. The system of claim 9, wherein at least one user is able to manipulate the at least one base map and vector data sets into at least one visual representation needed and then publish at least one report.

15. The system of claim 9, wherein the at least one user is able to prepare at least one map illustrating information to be saved in the at least one local cache for future use.

16. The system of claim 9, wherein the tiles generate at least one base map that is the bottom most layer and all other layers are placed upon that bottom most layer.
